(19) United States
(12) Patent Application Publication
(10) Pub. No.: US 2026/0126583 A1
(43) Pub. Date: May 7, 2026

(54) VOLUMETRIC OPTICAL DEVICES

(71) Applicant: THE BOARD OF TRUSTEES OF THE UNIVERSITY OF ILLINOIS, Urbana, IL (US)

(72) Inventors: Lynford L. Goddard, Urbana, IL (US); Paul V. Braun, Urbana, IL (US); Alexander J. Littlefield, Urbana, IL (US); Corey A. Richards, Urbana, IL (US); Christian H. Ocier, Urbana, IL (US); Dajie Xie, Urbana, IL (US)

(21) Appl. No.: 19/116,252

(22) PCT Filed: Sep. 29, 2023
(86) PCT No.: PCT/US2023/075602

§ 371 Date: Mar. 27, 2025

Related U.S. Application Data
(60) Provisional application No. 63/412,107, filed on Sep. 30, 2022.

(51) Int. Cl. G02B 6/12; G02B 1/10; G02B 6/13; G02B 6/30

(52) U.S. Cl. CPC G02B 6/12002; G02B 1/10; G02B 6/13; G02B 6/30; G02B 2006/12095

(57) ABSTRACT

A device includes a porous scaffold characterized by a scaffold refractive index. An optically written optic is embedded in the porous scaffold. A coating forms a surface of the porous scaffold. The coating includes the surface and a transition region. The surface is characterized by a surface refractive index. The transition region is characterized by a refractive index gradient that transitions between the surface refractive index and the scaffold refractive index

### PRIORITY

This application claim priority to U.S. Provisional Application No. 63/412,107, filed Sep. 30, 2022, bearing attorney docket no. 010422-22001A-US, and titled Volumetric Optical Devices, which is incorporated by reference herein in its entirety.

### STATEMENT REGARDING FEDERALLY SPONSORED RESEARCH OR DEVELOPMENT

This invention was made with government support under 1935289 awarded by the National Science Foundation. The government has certain rights in the invention.

### BACKGROUND

### Technical Field

The disclosure relates generally to volumetric optical devices.

### Brief Description of Related Technology

Rapid advances in communication technologies, driven by immense customer demand, have resulted in the widespread adoption of optical communication media. As one example, many millions of miles of optical fiber provide short and long haul optical communications throughout the world. Improved interconnects, optical processing, and integration with semiconductor based electronics will continue to increase demand.

### BRIEF DESCRIPTION OF THE DRAWINGS

FIG. 1 shows an example porous scaffold.

FIG. 2 shows an example coating fabrication method.

FIG. 3 shows an example porous scaffold.

FIG. 4 shows an example multi-session optic.

FIG. 5 shows an example multi-session optic writing method.

FIG. 6 shows an example ball optic with multiple step-index layers.

FIG. 7 shows an example porous scaffold with an example waveguide.

FIG. 8 shows example bend logic.

FIG. 9 shows example bend computation circuitry.

FIG. 10 shows an example two-dimensional optically-written voxel array.

FIG. 11 shows example illumination logic.

FIG. 12 shows example illumination control circuitry.

FIG. 13 shows example multi-pass optical writing logic.

FIG. 14 shows example dither logic.

FIG. 15 shows example multi-pass circuitry.

FIG. 16 shows example interval logic.

FIG. 17 shows example movement interval circuitry.

FIG. 18 shows an illustrative example set of written objects.

FIG. 19 shows an illustrative example set of analysis objects.

FIG. 20 shows example position control logic.

FIG. 21 shows example position control circuitry.

FIG. 22 shows an example porous scaffold with multiple arrays of voxels written.

FIG. 23 shows example visibility criteria logic.

### DETAILED DESCRIPTION

In various contexts, volumetric integrated photonic devices may be integrated with other optical and/or photonic devices. Accordingly, methods and devices for improving integration, reducing insertion loss, and improving overall photonic device quality will improve performance and drive adoption of technologies.

The various techniques and architectures discussed below provide for devices for coupling, free-space to guided-mode transitions, device writing with reduced writing artifacts and errors, waveguide bends, anti-reflective coating layers, and/or other volumetric integrated photonic device configurations and fabrication methods.

In various systems optical interconnects, e.g., optical elements interfacing one or more optical mediums to one or more other media (including other optical media), utilize specific three-dimensional forms to couple light among the media. Further, for complex and/or multiplexed routing and/or filtering, complex three-dimensional forms may be used. In some cases, processing operations on optical signals may use complex and/or specifically dimensioned forms. In addition, lensing may, in some cases, use two or three dimensional forms of a complex nature (e.g., as opposed to curved lenses or flat uncomplicated forms such as Fresnel lenses) which may be designed through computer modelling or empirical study. Such complex two- or three-dimensional forms may be impractical or impossible to create or to align accurately using standard lens manufacturing techniques alone. Accordingly, techniques and architectures that allow the creation of monolithically integrated optical devices, electro-optical devices, photonic elements, interconnects, waveguides, prisms, and/or other optics of arbitrary dimension, function, and form, such as those discussed below involving writing one or more voxels into a scaffold and/or writing an optic into such a scaffold, offer improvements over existing market based solutions.

In some systems, when writing a form to a medium, lower parts of a form provide support for the upper parts of the form because the writable medium (e.g., a polymer in liquid or aqueous form) provided no physical rigidity unless hardened through exposure. Accordingly, the conventional wisdom was that when constructing via laser writing an optic (e.g., into a polymer medium), the form of the optic should be selected such that the lower portions of the form would support the upper portions. In some cases, the inclusion of a scaffold provides rigidity within the writable medium allowing forms without support from lower portions of the structure, which allows one to proceed with structure selection that may be contrary to the conventional wisdom.

A scaffold may be saturated or immersed in writable media to define the writable volume. The scaffold, which may be porous, may host the writable media and may be transparent both in the presence of the writable media and in cases where the writable media is removed (e.g., after writing is complete or to allow for a second writable media to replace the first for additional writing stages). The writable media may include a writable medium (e.g., a medium for which the refractive index of the medium may change if the medium undergoes a material property change, such as a change that is optically induced or driven. A voxel may be written into the scaffold to create an optic. The scaffold may be disposed on a substrate (e.g., a silicon-on-insulator (SOI) compatible substrate, a Ill-V compatible substrate, or other substrate) which may allow for integration with other optics, electrical devices, and/or other systems. The scaffold may be rigid (e.g., a structure capable of holding written regions in a position in three-dimensional space at least when undisturbed and/or when exposed to ambient conditions). However, in various implementations, the scaffold may have varying degrees of flexibility when exposed to particular deforming forces.

In an example technique, a voxel is generated within a scaffold. The voxel may include a region that has undergone a material property change, such that the optical properties of the region are altered for an operational period (e.g., permanently, for multiple hours/days/months/years, over a decay period, a dissolution period, or other duration over which the written voxel may be used as (at least of portion of) an optic). The voxel may be written by focusing incident light into the voxel to cause the material property change. The material property change may include a refractive index change, a density change, a compositional change, a mechanical property change, an electrical property change, an acoustical property change, or other material property change, within a writable medium through optical absorption. Further, the material property change may cause the position of the voxel to be fixed within the scaffold. One or more voxels may be used to define an optic within the scaffold.

In other words, optics may be created such that the optics are written into an at least partially optically transparent porous scaffold permeated with a writable medium. The optics may be formed and arranged in a three-dimensional pattern. The optics may include regions having an optically-driven-state-changed writable medium.

The scaffold includes at least a partially rigid region. A writable volume may be included within or overlapping with the at least partially rigid region. The writable volume is defined via a writable medium that at least temporarily permeates the scaffold. The writable medium may include a substance for which an exposure to focused incident light may cause a material property change. In some cases, the optical absorption process may include a linear absorption process. However, in some cases, the optical absorption process includes a non-linear absorption process. For example, the process may include a two-photon, three-photon, and/or multi-photon absorption process. In some cases, use of a non-linear absorption process may allow the site of a voxel to be localized to the area exposed to the focus of a beam. In some cases, higher-order nonlinear absorption processes result in more localization than lower order nonlinear absorption processes. The higher the order of the nonlinear absorption process, the more photons that must be simultaneously absorbed to excite the process. Accordingly, the likelihood of excitation of the process, will increase dramatically (e.g., nonlinearly) near (or at) the focus of a focused incident light source (such as a laser or light emitting diode (LED)). Accordingly, a voxel may include the focal volume (or some portion of the focal volume) of the focused incident light source.

In some cases, the writable volume (e.g., the writable medium therein) may include a monomer, polymer, a photoresist, or a combination thereof. As an illustrative example, pentaerythritol triacrylate may be used. As another illustrative example, writable medium may include a self-assembled-monolayer-forming monomer. In this and other monomer examples, the monomer may form a polymer after cross-linking the monomer as a result of the optical absorption.

As discussed above, the scaffold may include a porous material. In various implementations, the porous material may include porous silicon, porous silicate, porous silica, porous gallium nitride, porous gallium arsenide, porous indium phosphide, porous lithium niobate, other porous Ill-V materials, porous high-temperature high-silica glass, any porosified nanofabrication substrate porous metallic materials, porous semiconductor materials, and/or porous dielectric materials. The particular scaffold may be selected based on the desired characteristics of the scaffold for a particular application. For example, porous silicon may be selected based on a birefringence of the porous silicon. In an example, the birefringence of the silicon may aid in phase-matching in a multi-wave mixing process.

In various implementations, porous materials that have been porosified via various processes may be used. For example, materials that have been porosified by uniform or non-uniform chemical etching may be used as a scaffold. Materials that have been porosified by uniform or non-uniform physical etching may be used as a scaffold. Materials that have been porosified by uniform or non-uniform electrochemical etching may be used as a scaffold. Materials that have been porosified by lithographic etching may be used as a scaffold. Materials that have been porosified by spatially selective etching may be used as a scaffold. Materials that are porous because of deposition at a glancing angle may be used as a scaffold. Materials made porous by assembly or that are porous because of assembly (including self-assembly) may be used as a scaffold. Porous materials, preferably with pores below 1 micron in at least one dimension, or more preferably below 100 nanometers, may be used as a scaffold. In some implementations, the size of pores may be controlled, e.g., by controlling the electrochemical etch current density. For example, pores may be selectively controlled to vary in size from up to 10 nm to 50 nm or more.

Further, a scaffold may be selected based on transparency constraints of a particular implementation. In various implementations, the transparency of the scaffold allows for exposure of the writable medium to focused incident light. In some cases, opaque scaffolds or scaffolds with limited transparency may prevent (or at least partially inhibit) exposure. Accordingly, a scaffold material may be constructed in various manners (such as any of those discussed above or other porosification processes). However, material selection to meet transparency constraints may be applied (at least in some cases) regardless of the porosification technique employed.

In some implementations, the level/intensity of the material property change may be selected. For example, the exposure may be lessened (reduced in intensity or duration) to reduce the overall change that occurs (e.g., reduce the change in refractive index either up or down). In another example, the exposure may be increased (increased in intensity or duration) to increase the overall change that occurs (e.g., increase the change in refractive index either up or down). Intensity may be increased or decreased by adjusting the input power of the incident light. Intensity may also be increased or decreased by varying the duty cycle for pulse width modulation. In some cases, intensity may be increased or decreased by adjusting the focal volume of the incident light. In some cases, the degree of the material change may be increased or decreased by varying the total exposure time.

The light source of the incident light may be a laser, a light emitting diode, a lamp, a flash lamp, an image projector, a fully or partially incoherent light source, and/or a fully or partially coherent light source.

Coating with Transition Region

In various implementations, coupling between one or more light-guiding media may be desired. For example, in some scenarios an operator may desire to couple multiple fiber-guided outputs into one or more inputs of a photonic chip or vice versa. In another example, an operator may desire to couple to or from a selected medium, but nevertheless fabricate optical devices within the porous scaffold at a refractive index different from that of selected medium. Thus, an optic written into a porous scaffold as discussed herein may implement coupling across media at different refractive indices. In some cases, where light traverses an interface over which a shift in refractive index occurs reflections may result. When coupling between devices, such reflections may cause loss or undesirable feedback into the light source.

In various implementations where a volume of a porous scaffold may be characterized by a scaffold refractive index that is different from that of a selected medium coupling to the scaffold, coupling between the porous scaffold and selected medium may be improved if the surface of the porous scaffold had a refractive index that was matched to that of the selected medium. Matching the refractive index of the selected medium at the surface of the porous scaffold ensures that reflections at the interface between the scaffold surface and the selected medium are reduced and/or eliminated. However, matching the surface refractive index of the porous scaffold may cause reflections to occur at interfaces between the scaffold surface (which is at the refractive index of the selected medium) and the internal volume of the porous scaffold characterized by the scaffold refractive index.

Various ones of the techniques and architectures discussed herein provide for a transition region characterized by a refractive index gradient that transitions from the surface refractive index to the scaffold refractive index. Thus, various implementations may include a porous scaffold with a coating characterized by a surface refractive index and a transition region with a refractive index gradient allowing for transition to the scaffold refractive index.

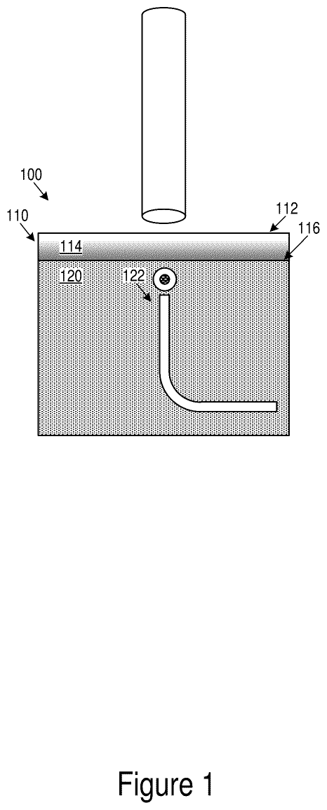

FIG. 1 shows an example porous scaffold 100. The scaffold may be characterized by a scaffold refractive index within the internal volume 120 of the scaffold, which may include written optics 122. The example scaffold may include a coating 110 characterized by a surface refractive index at a surface 112 of the coating. The coating 110 may include a transition region 114 the transition region 114 characterized by a refractive index gradient that transitions from the scaffold refractive index at the volume-coating interface 116 to the surface refractive index at the surface 112. The volume-coating interface 116 may include the interface at which the coating 110 and the internal volume 120 meet. In some implementations, the internal volume 120 may be occupied by cavities (up to 80%-90% or more) due to the porosity of the scaffold. The scaffold refractive index (e.g., other than within written optics) may be near that of an ambient index, such as air, vacuum, and/or other ambient environment.

In various implementations, the coating 110 may be formed by diffusion and/or other processes that may generate a diffuse volume-coating interface 116. Thus, the volume-coating interface 116 does not necessarily form a defined material boundary with the internal volume 120. As discussed herein, the volume-coating interface 116 may be used for the purposes of illustration rather than to denote a defined material boundary. Moreover, because the volume-coating interface is refractive-index-matched to the internal volume, the volume-coating interface 116 may not necessarily provide a visual or optical boundary, even in implementations where the coating is distinct from the internal volume 120 with regard to material content.

The coating 110 may facilitate coupling between coupled media 130 and one or more optics 122 written within the internal volume. The refractive index gradient of the coating 110 may ensure a gradual transition from the index of the coupled media 130 (e.g., the selected media index and to which the surface refractive index is matched) to the index within the internal volume 120. The gradual transition may prevent and/or reduce reflections as light travels between the coupled media 130 and the internal volume 120.

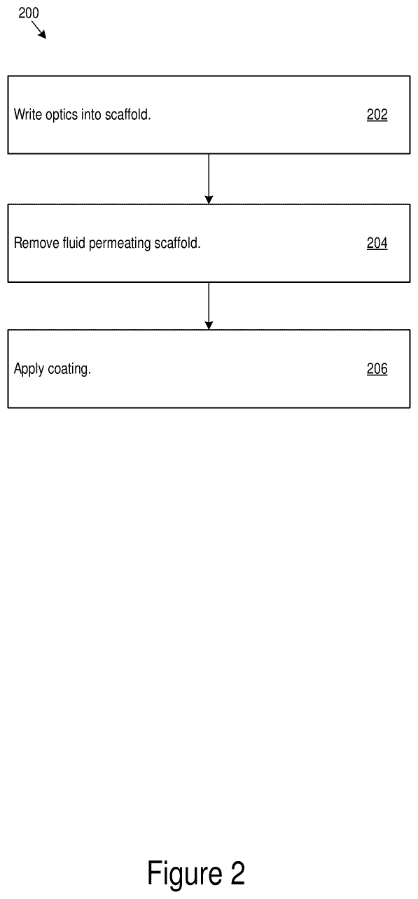

FIG. 2 shows an example coating fabrication method 200. Optics may be written into the porous scaffold (202). The cross-linking fluid permeating the scaffold may be removed after writing to produce a developed scaffold with completed optics (204). The coating may be applied onto the surface of the scaffold (206) to create the refractive index gradient.

Generating the refractive index gradient may rely on various application techniques for the coating.

In various implementations, coating may be applied by allowing an index-matched material (e.g., index-matched to the selected coupling media) to diffuse into the porous scaffold. Diffusion of the index-matched material creates a gradient based on the amount of diffused material. As distance increases from the surface of the scaffold increases the amount of index-matched material that diffuses to that depth decreases. Thus, the ratio of scaffold material to index matched material as depth into the scaffold increases due to the limited travel of the diffused index-matched material. The ratio of scaffold material to index matched material defines the effective refractive index at any point within the coating. Accordingly, a diffusion profile, e.g., a varying concentration with depth, is created by diffusing the material into the scaffold. The diffusion profile may define the depth-varying refractive index of the transition region. In some implementations, the index-matched material is a liquid whose viscosity and optical properties are chosen such that the desired index profile is achieved after diffusion. In some cases, the index-matched material is delivered via a carrier gas that diffuses into the pores and allows the material to adhere to the pore walls. In some cases, the index-matched material is a solid material such as a dielectric that is evaporated and diffuses into the pores.

Additionally or alternatively, multi-layer application may be used to apply the coating. Multi-layer application may include depositing the coating layer-by-layer, where successive layers have different refractive indices. The different refractive indices of the successive layers progressing from the surface refractive index at one side of the coating to the scaffold refractive index at the other side of the coating. For example, the coating may include silicon oxynitride layers where the different layers of the coating have different levels of silicon enrichment. In various examples, the layers may include different members of the SiNx system to effect a progression of indices among the successive layers.

In various implementations, continuously varying (or continually varied) deposition methods may be used. For example, a deposition process with varying concentration and/or chemical makeups may be used. For example, a graded index system may be created by depositing silica with increasing concentrations of silicon oxynitride through to pure silicon oxynitride and eventually through members of the silicon nitride system. In some cases, the porous scaffold may be diffusively infilled with silica before the continuously varying deposition process. The various deposition processes may be readily combined to generate larger index gradients.

In some cases, the coating may be porous. For example, the coating may be created using an electrochemical etch process similar to that used to create the porous scaffold. The current density of the electrochemical etch process may be tuned during deposition of the coating, such that the current density matches that used to create the internal volume at the volume-coating interface and is then reduced with increasing distance from the internal volume to create relatively more non-porous material at the coating surface. A quarter-wave thickness coating may be created using the electrochemical etch process. A multi-layer anti-reflection coating with either a set of discrete refractive indices or a set of continuously varying refractive index profiles may be created using the electrochemical etch process.

The coating may have different thicknesses ranging from less than a micron for quarter-wave type coatings up to multiple microns or more for multi-layer coatings and diffusion-based coatings.

Various silicon including materials, semiconductor materials, glass materials, and/or other materials may be used to form coatings, e.g., to create a range of implementable refractive indices varying from indices near to that of an ambient environment (e.g., air or vacuum) to indices above that of silicon. Thus, refractive indices of virtually any pair of coupling media may have a tailored coating that transitions from the index of one to the index of the other over the coating's corresponding refractive index gradient.

### End Coupler

In various implementations, coupling between an external light source/target (such as an external waveguide) and a waveguide within the porous scaffold may be desired. In some cases, coupling into (or out of) the porous-scaffold waveguide may be improved using an end coupler structure. An end coupler structure may include an optically-written optic spaced apart from (but proximate to) an end of the porous-scaffold waveguide.

In various implementations, various end coupler shapes may be used. For example, ball-shaped couplers may be used. In some implementations, polyhedrons, ellipsoids, irregular 3-d shapes, optical resonator shapes, and/or other forms may be used.

In some implementations, end couplers may have uniform refractive index over their form. In some implementations, the refractive index of various portions of the end coupler may have different refractive indices allowing for contrast within the device and structural complexity other than that contributed by device shape. As an example, a Luneburg lens may be implemented. A Luneburg lens may be ball-shaped with a continuously varying refractive index along its radius. The varying refractive index over the volume of various end couplers may be created by varying the laser exposure time and/or power during optical writing. Longer and/or stronger exposure may generate regions of denser polymer cross-linkage and, as a result, increased refractive index. Additionally or alternatively, varying refractive index may be generated using multi-session writing as discussed below.

In some implementations, the end coupler may be shaped to mode-match a particular input source at one end and mode matched to the porous-scaffold waveguide on the other end. For example, the end coupler may be tear drop shaped, allowing for a rounded end for coupling to one source or output and a tapered end for coupling to the other source/output. The taper may, in some implementations, serves to improve the mode-matching, for example, when the output mode of the waveguide is highly divergent.

In various implementations, the porous-scaffold waveguide may be tapered on the end approaching the end coupler to allow for more available configurations for improving mode matching between the end coupler and the porous-scaffold waveguide. In some implementations, the external light source/input may include a waveguide that has a tapered end for coupling with the porous-scaffold waveguide.

In some implementations, the end coupler may be proximate to the end of the porous-scaffold waveguide. For example, the end coupler may be in contact with the end of the waveguide, be spaced away from the end of the waveguide, and/or the end of the waveguide may terminate within the end coupler. For example, a tapered-end waveguide may protrude slightly into the volume of the end coupler.

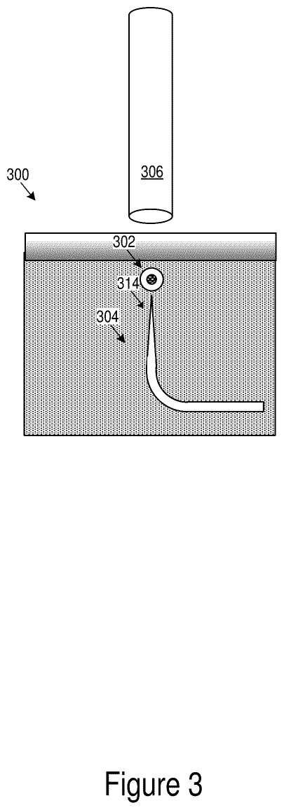

FIG. 3 shows an example porous scaffold 300. In the porous scaffold 300 may have an end coupler 302 to support coupling to a waveguide 304 within the porous scaffold. The end coupler 302 may support coupling between an external waveguide 306 and the porous-scaffold waveguide 304. The example porous scaffold 300 is shown paired with an external waveguide 306 as an illustrative example, but other external sources/inputs may be used. The end coupler 302 may be spaced away from the porous-scaffold waveguide 304. The porous-scaffold waveguide 304 may include a taper 314. The porous-scaffold waveguide 304 may include a bend to enable the direction of light propagation at the output to be different than that in the external waveguide.

In various implementations, the end coupler may be written using various methods including, bottom-up writing (e.g., beginning writing at the bottom of the optic and working upwards), top-down writing (e.g., beginning writing at the top of the optic and working downwards), a mixture of bottom-up and top-down (e.g., beginning writing at the bottom of the optic and working up and subsequently beginning at the top of the taper and working down) and/or using various ones of the optical writing processes discussed below using multi-session writing, multi-pass writing, dither, transfer functions, frame stitching, equal time between actuator movements, laser stability analysis, and/or other writing processes.

Additionally or alternatively, the writing process may be a multi-session writing process. In a multi-session writing process, one or more optically-written optics are written using one or more overlapping writing sessions. The individual ones of the writing sessions may use the various ones of the optical writing processes discussed below including transfer functions, frame stitching, equal time between actuator movements, laser stability analysis, and/or other writing processes. Multi-pass writing, in which a particular line or frame is overwritten using the same or approximately the same locations for the voxels, may be used within the individual sessions. Multi-pass writing may be used to increase the refractive index contrast or to reduce the roughness of written features. Multi-session writing is different from multi-pass writing because multi-session writing includes overwriting a written location (at least in part) with a different shape to create refractive index contrast. For example, a ball-shaped coupler (e.g., a ball lens) may be written in multiple sessions. A first session may be used to write a low index ball (e.g., using a low laser power). A second session may be used to write a smaller concentric ball of higher resultant index (e.g., using a high laser power or using a low laser power with multi-pass writing) over the center of the low index ball. Thus, a ball lens with a step-index change along the radius of the ball lens is created. Other complex multi-index optics may be written using multi-session writing.

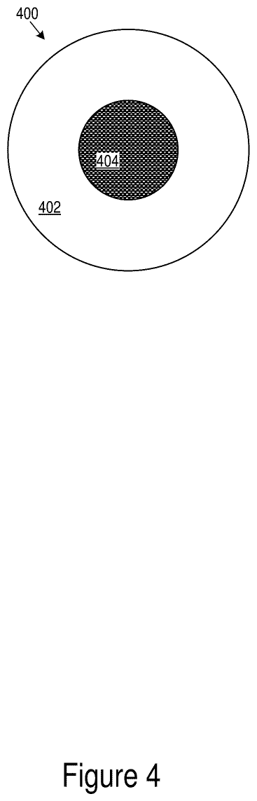

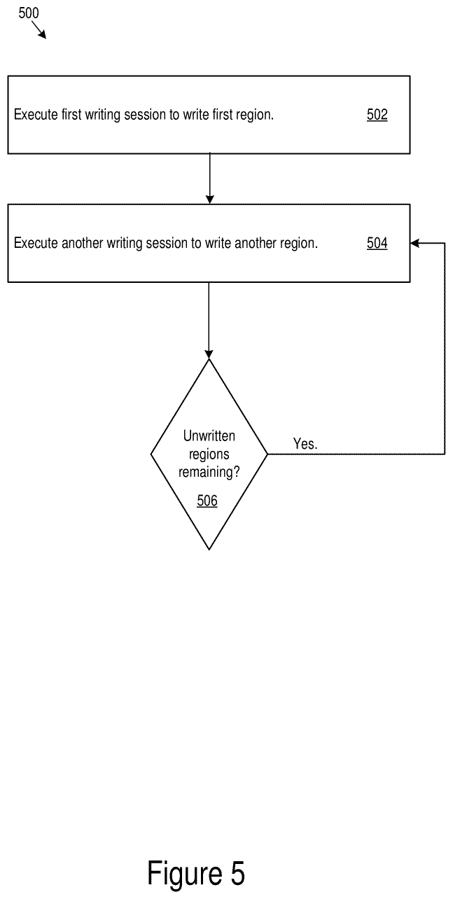

FIG. 4 shows an example multi-session optic 400. Referring also to FIG. 5, a multi-session optic writing method, which may be used to write the multi-session optic 400, is shown. The multi-session optic 400 may include a first region 402 and a second region 404. In the example multi-session optic 400, the second region 404 is contained within the first region 402. However, in other examples, smaller regions may not necessarily be contained entirely within a largest region. A first writing session may be used to write the first region (502). A second writing session may be used to write the second region (504). While the sessions may be executed with either session being executed before the other, in various implementations, a current session may complete before another session is started. The writing sessions may continue (506) until all regions are written.

In the example, the second region 404 is contained within the first region 402. Therefore, the volume of written voxels for the second session may be fewer than that of the first session and overlapping with a portion of the voxels written in the first session. Accordingly, the second session may include a ‘subset session’ while the first session may include a ‘superset session.’ In some cases, even though the volume of the subset is contained in the volume of the superset, the physical locations of the written voxels of the subset may not be the same as those in the superset. For example, the first region 402 superset could be a ball of diameter 18 microns with voxels on a regular grid that has a period of 100 nanometers in each of the three directions while the second region 404 subset could be a concentric ball of diameter 15 microns with voxels on a grid of the same period but offset by 50 nanometers in one or more directions.

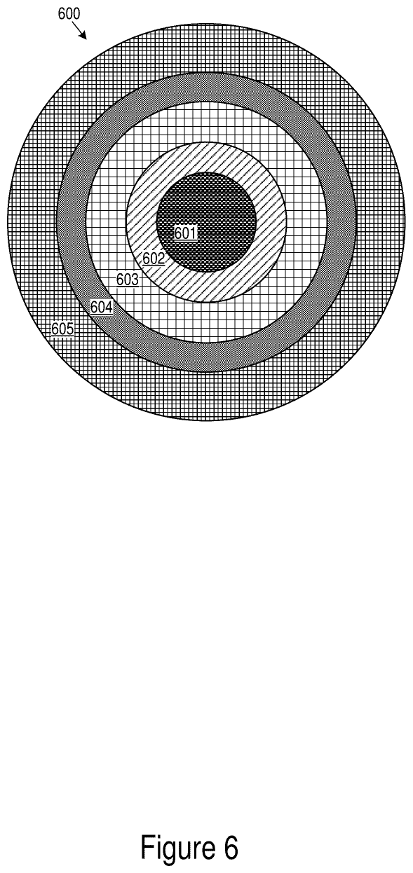

FIG. 6 shows another an example ball optic 600 with multiple step-index layers. The multiple-step index layers 601-605 may be used to approximate a Luneburg lens and/or other ball lens with a radially varying refractive index profile. The multiple-step index layers 601-605 may be written as different regions over multiple sessions.

### Cross Section Transition Bend

In various implementations, it may be desirable to write a waveguide within a porous scaffold with a bend. Additionally or alternatively, it may be desirable to transition from a first waveguide cross section to a second waveguide cross section. As an illustration, a waveguide may be used for external coupling (into or out of the porous scaffold) in a first orientation then undergo a bend for routing within the scaffold in another orientation. The cross section of the waveguide used for coupling may be different from that used for routing within the scaffold. Additionally or alternatively, the selected cross section to support writing the waveguide in the scaffold may differ based on the orientation of the waveguide. For example, the selected arrangement of voxels may differ if the waveguide is being written parallel to the beam of the writing laser as opposed to transverse to the beam of the writing laser. Additionally or alternatively, the cross section transitioning may be used to achieve bends with a particular bending radius while controlling loss over the bend.

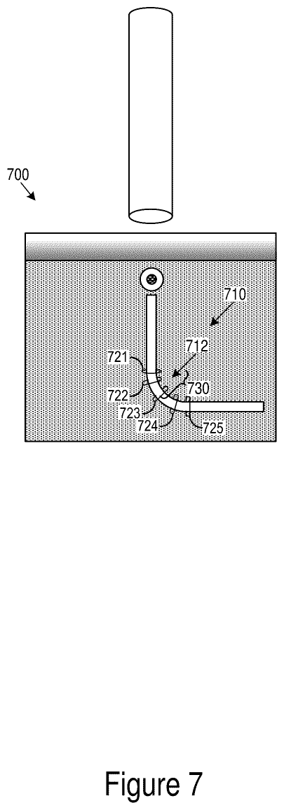

FIG. 7 shows an example porous scaffold 700 with an example waveguide 710. The example waveguide 710 includes a bend 712 with cross sections 721-725 that transition from an elliptical cross section 721 while the waveguide 710 is vertically oriented to a rectangular cross section 725 while the waveguide is horizontally oriented. The intermediate cross sections 722-724 show progression of the cross section from the elliptical cross section 721 to the rectangular cross section.

In the example waveguide, the progression of the cross section allows the function of the waveguide 710 to transition from supporting external coupling in the vertical orientation to supporting in-scaffold routing in the horizontal orientation. Moreover, the mode matching provided by the controlled cross section progression allows the waveguide 710 to achieve a 90 degree bend with the selected bend radius 730 of the waveguide.

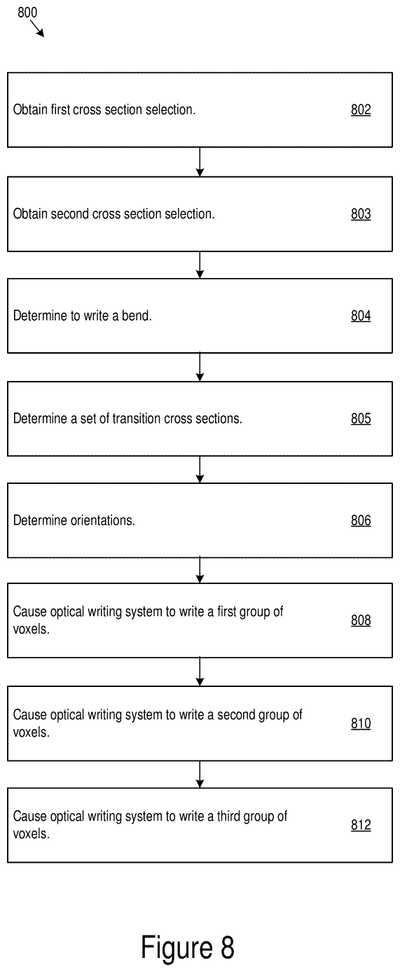

FIG. 8 shows example bend logic 800 for determining a waveguide bend write pattern. The bend logic 800 may obtain a first cross section selection for a first portion of a waveguide oriented for travel along a first axis (802). The bend logic 800 may obtain a second cross section selection for a second portion of a waveguide oriented for travel in along a second axis (803).

The bend logic 800 may determine to write a bend such that the two portions are connected upon writing the waveguide (804). The bend logic 800 may determine a set of transition cross sections mapping to a transformation from the first cross section to the second cross section (805). The logic 800 may determine orientations for the set of transition cross sections to transition propagation of light in the waveguide between the first and second axes (806).

The bend logic 800 may cause an optical writing system to write a first group of voxels for the first portion of the waveguide consistent with the first cross section (808). The bend logic 800 may cause the optical writing system to write a second group of voxels for the second portion of the waveguide consistent with the second cross section (810). The bend logic 800 may cause the optical writing system to write a third group of voxels for the bend within the waveguide consistent with the determined transition cross sections (812).

In various implementations, the first and second cross sections may be determined by factors such an internal waveguide structure, ease of waveguide writing, efficient external coupling and/or other factors. Accordingly, the bend logic 800 may, in some cases, obtain the first and/or second cross sections by accessing predetermined cross section selections.

In various implementations, the writing of the various portions of the waveguide may executed in varying orders. For example, the waveguide may be written bottom-up, top-down, a mixture of both, and, from various other orientations. Accordingly various ones of the first portion, the second portion, and/or the bend may be written in parallel, in succession, or in parts over multiple sessions. Thus, the write order of the various portions of the waveguide may be independent of the planning/computation order of the portions of the waveguide.

Additionally or alternatively to write order concerns write quality concerns may influence the selection of the writing method used to write the waveguide. For example, the waveguide may be written using various methods e.g., using multi-session writing, multi-pass writing, dither, transfer functions, multisession writing, frame stitching, equal time between actuator movements, laser stability analysis, and/or other writing processes.

In various implementations, multi-session writing and multi-pass writing may be used to smooth and/or enhance refractive index contrast for a waveguide. Overwriting written waveguide portions with an additional overlapping set of voxels may result in smoothing due to the slight misalignment of the multiple writing passes and/or increased contrast (e.g. relative to the scaffold background) due to increased crosslinking.

In various implementations various curves may be used. For example, a bend may be written such that the bend traces a circular arc. For example, a bend may be written such that the bend traces a Bezier curve. In some cases, a particular curve may be used to control losses within the waveguide bend, better adapt the bend for writing from a particular orientation, to better match to the cross sectional transition being executed within the bend, and/or conform to other waveguide writing factors or constraints.

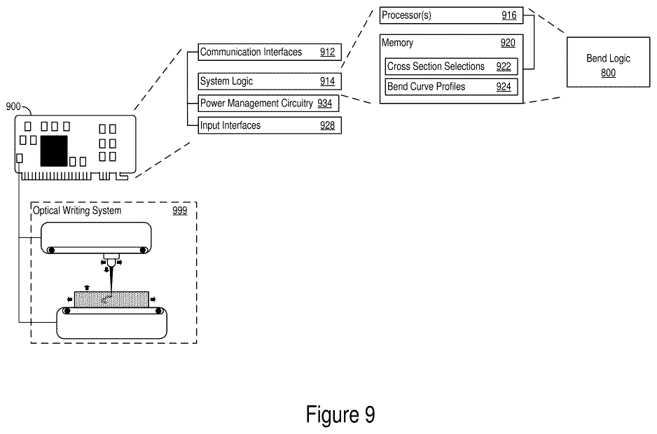

FIG. 9 shows example bend computation circuitry (BCC) 900 for computation of transition cross section shape and/or orientation. The BCC 900 may provide a hardware environment for execution of the bend logic 800. The BCC 900 may include system logic 914 to support bend curve selection and/or computation, cross section analysis, transformation, and/or orientation computation. The system logic 914 may include processors 316, memory 920, and/or other circuitry, which may be used to implement the example bend logic 800.

The memory 920 may be used to store cross section selections for various portions of different waveguide and/or bend curve profiles 924 (e.g., that detail angle progression and sizing for various curves).

The memory 920 may further include applications and structures, for example, coded objects, templates, or one or more other data structures to support iterative search operations. The BCC 900 may also include one or more communication interfaces 912, which may support internal bus communications, wired/wireless data communication, and/or other operational input. The BCC 900 may include power management circuitry 934 and one or more input interfaces 928 for operator input and/or other operational control.

The BCC 900 may be coupled to an optical writing system 999 for execution of waveguide writing.

### Adjusted Power Lookup

In various implementations, optical writing systems may have a write power variance based on the write position of writable points within a write field. Accordingly, when writing at uniform power/exposure time, voxels written in the write field may vary in refractive index although nominally written at the same illumination power with the same exposure time.

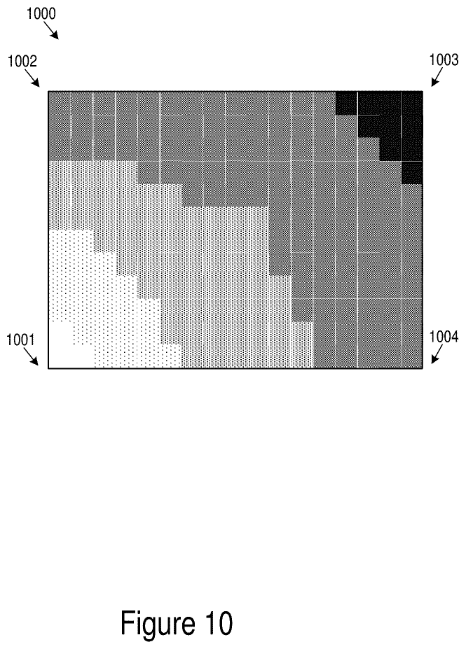

FIG. 10 shows an example two-dimensional optically-written voxel array 1000. The illustrative example two-dimensional optically-written voxel array 1000 was written at uniform operational output power with constant exposure times for each voxel. Despite the uniformity of the nominal output of the optical writing system, the example two-dimensional optically-written voxel array 1000 exhibits non-uniform written voxels. Voxels in one corner 1001 of the example array 1000 have less dense cross-linking than voxels in other portions 1002-1004 of the example array 1000.

In various implementations, the non-uniformity may be power level dependent. In other words, at different selected operational power levels, the non-uniformity of voxel writing in a given array may change. For example, no non-uniformity may be present at a first operational power level, but non-uniformity may be present at a second, different operational power level. In various implementations the pattern of non-uniformity may change in addition to presence/absence differences.

In some implementations, an optical writing system may use an adjusted power data structure including correction entries for optical writing power. For example, the entries may include a scaling factor for adjustment of a power level that may indicate how much a particular power level (or exposure—power and duration) should be increased. The entries may include corrected absolute power levels. For example, for a particular selected effective power, the entries may include a corrected power. The corrected power may include an absolute power level rather than a scaling factor for the selected effective power. Thus, an adjusted power from the adjusted power data structure may include a scaling factor and/or a substitute absolute power level.

The adjustments to the power may be power dependent. Accordingly, some systems may rely on a scaling factor for adjustment entries, while other systems may use power as a lookup input to allow for non-linear correction to power level. The adjustments to the power may be time dependent. Accordingly, some systems may rely on measurement of the power at the moment of writing and applying a scaling factor or a lookup input to allow for temporal correction to power level.

The entries may be point-specific within the write field. In other words, the correction entries may be specific to particular actuator coordinates for the optical writing system. For example, a write field may be defined by points accessible via motion of one or more actuators. In some cases, actuators of the same type (e.g., motor-type, movement-type (rotary, angular, linear-translation, or other movement), spot-focus-moving-type, scaffold-moving-type, and/or other type) may define a write field. A new write field may be created when actuators of a different type are moved. Thus, write fields may include a one-dimensional space (e.g., a line, arc, or other curve), a two-dimensional space (e.g., a plane or other surface), a volume, or a multi-dimensional actuator space (as discussed below). As an illustration, a write field may include a two-dimensional plane created by the movement of a linear translation actuator that translates the spot-focus of the writing laser and a galvanometer that translates the spot-focus of the writing laser changing the angular deflection of a mirror. When a third actuator (e.g., z-axis translation) is moved, the two-dimensional plane is translated so as to create a new write field in a new z-axis location. Thus, in this illustrative example, the lookup inputs to the adjusted power data structure include only the two-dimensional plane actuator coordinates. In an alternative illustrative example scenario, the z-axis location is additionally included in the lookup. In this alternative example scenario, the write field is a volume rather than a plane.

In some cases, an optical system may use more than three actuators to move through a volume. In some cases, due to the type of actuator (e.g., galvanometer vs. linear stage, etc.), the entity moved by the actuator (spot-focus movement vs. scaffold movement), and the movement accuracy of the actuator, the power may depend on the actuator positions rather than the specific point within space. In other words, a point in space may be accessible through multiple different actuator position combinations. Accordingly, a write field may be defined using more than three actuator position coordinates to create a multi-dimensional actuator space.

In some cases, the system may use multiple different write fields in parallel. For example, each of multiple actuators may have a corresponding write field defined for the actuator. Thus, to determine an adjusted power, the system may perform multiple lookups, e.g., one for each relevant write field.

In some cases, the adjusted power entries may be populated by determining a spatially-varying optical transmission function (SOTF). A SOTF may be determined by performing one or more test writing sessions to characterize a write field. The test writing sessions may include writing voxels in a test scaffold at selected points within a write field. The selected points may include each point in the write field, in some cases. In some cases, the selected points may include sampled points (e.g., spatially periodic sampling, random sampling, sampling clustered at locations of steep change (gradient-dependent sampling), or other sampled selection). The test writing sessions may be performed at one or more writing power levels. After the test writing sessions are completed, the written scaffolds are analyzed for spatial dependence with regard to written contrast. In some cases, the spatial dependence is determined by collecting fluorescence microscopy images. The fluorescence intensity has a monotonic relationship with the density of crosslinked polymer and the density has a monolithic relationship with the refractive index. In some cases, the spatial dependence is determined by collecting brightfield, darkfield, confocal, or other form of optical microscopy images. The grayscale intensity and/or color values of such images may have a monotonic relationship with the density of crosslinked polymer and thus with the refractive index.

The spatial dependence of the test written sample fields (e.g., captured within the test written scaffolds), may be inverted to determine power adjustments that would result in spatially-uniform writing at each tested power level. Subsequent writing sessions may be performed to realize spatially-uniform writing of optical elements such as Fresnel biprisms from which the refractive index for a given adjusted power level can be determined. The power adjustments serve as the SOTF and may be used to populate the adjusted power data structure. The data structure may store the power necessary to achieve a desired refractive index at a specific point in the write field. The data structure may store the power necessary to achieve a desired fluorescence, grayscale, or color intensity at a specific point in the write field in cases where the determination of the refractive index is not needed or not performed. For systems characterized via sampled test writing sessions. Unsampled points within a write field may be interpolated (or denoised via a neural AI model) to obtain the unsampled values.

The range of power levels tested may be selected based on the selection of optics to be written by a particular optical writing system. Accordingly, the range of power characterization may be matched to the (known or expected) operating range of the system under test.

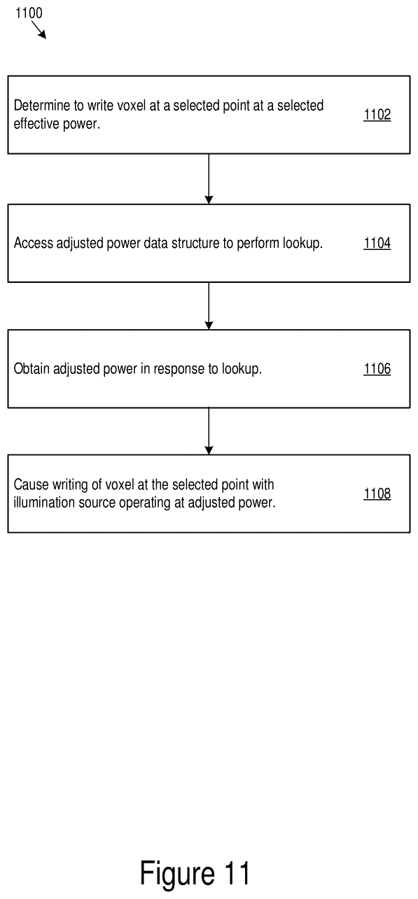

FIG. 11 shows example illumination logic (ICL) 1100. The ICL 1100 may obtain an instruction for an optical writing system to optically write a voxel at a selected point within a write field at a selected effective power (1102). For example, the ICL 1100 may receive a set of optical writing instructions for optics within a scaffold. The instructions may include positions of voxels and indications of exposure levels (and/or desired index contrast levels) for the voxels designated for writing by the set of instructions. The exposure levels and/or desired index contrast levels may be translated to selected effective powers for optical writing by the system (e.g., based on power level characterizations for the system). The positions of the voxels may be translated to points within the write field (e.g., actuator coordinates) based on relative positions to various markers within the scaffold of other position references for the scaffold, such as distance from faces, edges, and/or other relative distances.

The ICL 1100 may access an adjusted power data structure to perform a lookup using the location within the write field and/or the selected effective power to determine an adjusted power that produces the selected effective power at the location within the write field (1104). The adjusted power data structure may return an indication of the adjusted power to the ICL 1100 in response to the lookup (1106). The ICL 1100 may then cause optical writing of the voxel at the selected point with the writing illumination source set at the adjusted power (1108). For example, the ICL 1100 may generate power-adjusted optical writing instructions to supplant the received instructions. The adjusted optical writing instructions may be sent to the optical writing system for execution. In some implementations, the ICL 1100 may operate nested within the logic of the optical writing system and may determine adjusted powers in real-time as writing instructions are received and executed by the optical writing system.

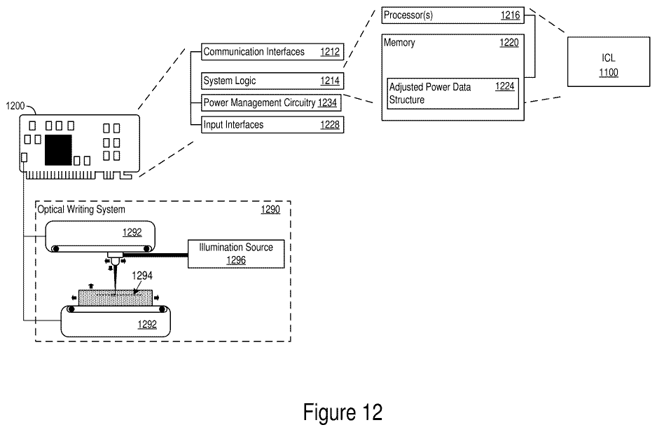

FIG. 12 shows example illumination control circuitry (ICC) 1200 for illumination power adjustment in an optical writing system. The ICC 1200 may provide a hardware environment for execution of the ICL 1100. The ICC 1200 may include system logic 1214 to support power adjustment lookup, instruction translation, and/or other operations to support adjustment lookup and instruction correction. The system logic 1214 may include processors 1216, memory 1220, and/or other circuitry, which may be used to implement the example illumination control logic 1100.

The memory 1220 may be used to store the adjusted power data structure 1224 which may include entries for points and/or one or more power levels within one or more write fields.

The memory 1220 may further include applications and structures, for example, coded objects, templates, or one or more other data structures to support power adjustment and/or illumination control. The ICC 1200 may also include one or more communication interfaces 1212, which may support internal bus communications, wired/wireless data communication, and/or other operational input. The ICC 1200 may include power management circuitry 1234 and one or more input interfaces 1228 for operator input and/or other operational control.

The ICC 1200 may be coupled to an optical writing system 1290 for execution of waveguide writing. The optical writing system 1290 may include one or more actuators 1292, which may control position within a write field 1294. The optical writing system 1290 may further include an illumination source 1296, which may include (or be paired with, if external to the illumination source 1296) a controllable power output. The controllable power output may be used to implement the adjusted power instructions from the ICL 1100.

### Multi-Pass Optical Writing

Multi-pass optical writing may include optical writing where the same volume is overwritten using voxels that are the same or slightly shifted in each of the multiple writing passes. Multi-pass writing may be different from multi-session optical writing because in multi-session optical writing, at least some of the voxels are written in a different volume in each of the different sessions.

In various implementations, optically writing an optic using a single writing pass may generate an optic with one or more characteristics that may, in some scenarios, reduce optic quality relative to optics where such characteristics are not present. For example, single pass writing may result in optics with comparatively less refractive index contrast to those generated via multi-pass writing. In an example, a single writing pass may result in more individually-defined voxels that make-up an optic. The “roughness” created by the well-defined individual voxels may reduce the quality of the written optic. Multi-pass writing may include overwriting voxels that interleave the voxels from the first writing pass to achieve inter-voxel smoothing and/or increased refractive index contrast with the background porous scaffold. Thus, multi-pass may reduce or remove characteristics that reduce written optic quality. In the example of a microring resonator, multi-pass writing using the same voxels in each pass can increase the quality factor of the resonator because the bending loss is reduced due to higher index contrast. Additionally or alternatively, multi-pass writing using different voxels within the same microring volume can also significantly increase the quality factor because the propagation loss is reduced due to smoother side walls in addition to reduced bending loss from the higher index contrast.

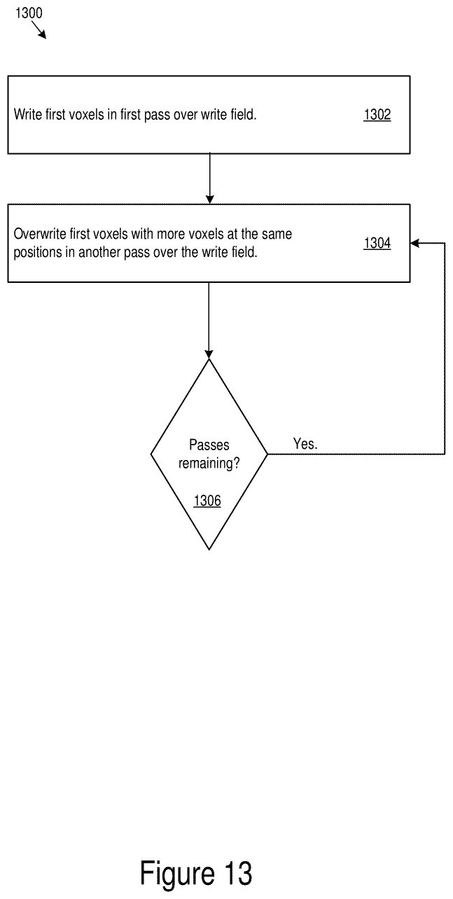

FIG. 13 shows example multi-pass optical writing logic (MOWL) 1300. The MOWL 1300 may cause an optical writing system to write first voxels in a first pass over a write field (1302). The MOWL 1300 may cause the optical writing system to write second voxels that overlap with the first voxels in a second pass over a write field (1304). The MOWL 1300 may repeat the passes to overwrite the first voxels until a selected number of passes has been completed (1306).

In some implementations, actuator dither, a specific multi-pass technique, may provide inter-voxel smoothing and/or increased refractive index contrast provided by other multi-pass techniques, but may further provide smoothing that corrects for artifacts due to actuator motion. In some implementations, some such artifacts due to actuator motion may persist even after multi-pass writing (without actuator dither) is performed. The persistence of the artifacts may be due to error in actuator motion. As an illustrative example, a linear-translation-stage type actuator may have an incremental step corresponding to a minimum translation distance and/or position resolution. In some cases, the increment may vary due to a flaw, e.g., from manufacturing tolerances, motor quality, defects, and/or device wear. In some cases, errors caused by such a flaw may be present in each pass of the stage. In other words, the error occurs each time the stage moves over that same portion of the stage's travel. In another illustrative example, a piezo-type actuator may have position errors to voltage noise, crystal defects, and/or other flaws. In another illustrative example, a galvanometer-type actuator may have position quantization that may prevent uniform continuous angle deflection and result in step-wise incremental movement, which may generate patterns within the written voxels.

Dither may include writing a first pass over a write field using a first actuator, moving with a second actuator, compensating (with the first actuator) such that the second actuator move is undone, and then performing a second pass over the write field with the first actuator. As a result, the second pass may be performed at different portions of the travel of the first actuator despite the writing being targeted to overlap with the voxels from the first pass. In other words, the write field is shifted with respect to the travel of the first actuator. Because the voxels are rewritten using a different portion of the first actuator's travel, errors in motion for the first actuator may be averaged out.

In some cases, the compensation may be performed by a third actuator, e.g., to correct for motion error by the second actuator. Additionally or alternatively, multiple actuators may be used compensate for the move of the second actuator. For example, travel by the second actuator may include a component that is orthogonal to the travel of the first actuator. Accordingly compensation by the first actuator alone may not necessarily be possible, where such an orthogonal component of motion is present.

In some implementations, compensation may be performed with actuators of different types to correct for artifacts that may be present in all actuators of a given type. However, in various implementations, some or all compensation may be performed using actuators of the same type. Same-type actuator compensation may correct for individual-actuator specific artifacts, such as device flaws and/or manufacture variance.

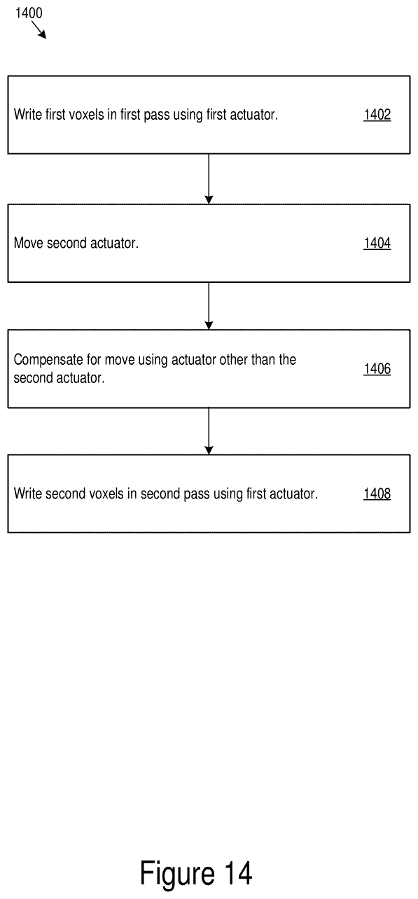

FIG. 14 shows example dither logic 1400. The dither logic 1400 may cause an optical writing system to write a first group of voxels in a first writing pass over a write field using a first actuator (1402). The dither logic 1400 may cause a move by second actuator of the optical writing system (1404). The dither logic 1400 may compensate for the move using an actuator other than the second actuator (1406), for example, the first actuator. The dither logic 1400 may cause the optical writing system to write a second group of voxels overlapping with (or proximate to) the first group of voxels in a second pass over the write field using the first actuator (1408).

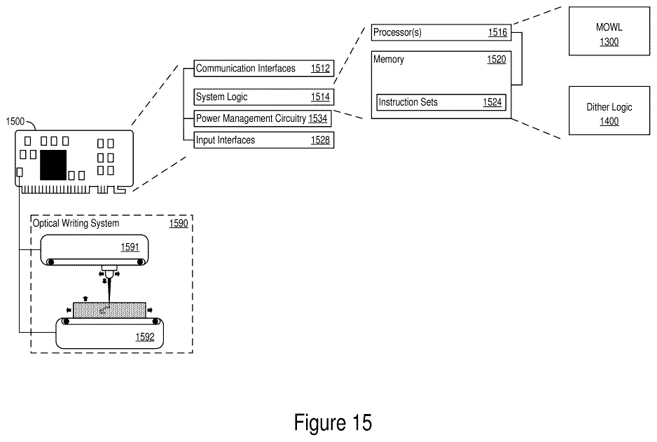

FIG. 15 shows example multi-pass circuitry (MPC) 1500 for multi-pass writing with an optical writing system 1590. The MPC 1500 may provide a hardware environment for execution of the MOWL 1300 and/or dither logic 1400. The MPC 1500 may include system logic 1514 to support multi-pass motion, multi-actuator control, move compensation, and/or other operations to support multi-pass writing and/or dither. The system logic 1514 may include processors 1516, memory 1520, and/or other circuitry, which may be used to implement the example MOWL 1300 example dither logic 1400.

The memory 1520 may be used to store the actuator instruction sets 1524. The memory 1520 may further include applications and structures, for example, coded objects, templates, or one or more other data structures to support multi-pass motion, multi-actuator control, move compensation, and/or other operations to support multi-pass writing and/or dither. The MPC 1500 may also include one or more communication interfaces 1512, which may support internal bus communications, wired/wireless data communication, and/or other operational input. The MPC 1500 may include power management circuitry 1534 and one or more input interfaces 1528 for operator input and/or other operational control.

The MPC 1500 may be coupled to an optical writing system 1590 for execution of multi-pass writing. The optical writing system 1590 may include first and/or second actuators 1591, 1592, which may be used for multi-pass writing and/or dither operations.

### Constant Scan Step Interval

In various systems, the time interval between writing voxels may affect the degree of polymerization. For example, the writing of a voxel may produce localized heating that affects the crosslinking process for subsequently written nearby voxels. In some cases, the writing of a voxel may alter the local concentration of available reactants and thereby also affect the crosslinking process for subsequent voxels.

In various systems, the time interval between movements by an actuator may affect the nature of the error in motion by the actuator. For example, an actuator may have different behaviors for different between-movement intervals, due to different settling, state refresh, discharge states, and/or other time varying conditions. In some cases, the actuator may exhibit one range of error when a first between-movement interval is used and a different range of error when a second between-movement interval is used.

In some implementations, the behavior of crosslinking process and the behavior of the actuators may be stabilized by using a constant between-movement interval for individual actuators used in an optical writing system. For example, for any particular actuator, the time between movements by that actuator may be constant for an optical writing task. The between-movement interval for a particular actuator may not necessarily be the same as that for any other actuator used in the writing task. For example, a first actuator may scan across the distance it travels over an ‘X’ axis for a scan in a series of scan steps. Once the first actuator completes its scan, a second actuator may execute a single scan step over a ‘Y’ axis. The first actuator may then scan back over the ‘X’ axis in another series of scan steps, with the second actuator once again executing the single ‘Y’ scan step upon completion by the first actuator. The process may continue until the second actuator completes its scan over the ‘Y’ axis. Because there is a scan by the first actuator over the ‘X’ axis between each scan step by the second actuator, the time between scan steps by the second actuator is constant. The interval between steps for the first actuator may similarly be kept constant through similar regulation of other actuators on which the first actuator's scan step timing depends, for example a third actuator for movement in over a ‘Z’ axis.

In some implementations, the time between scan steps for an actuator may be the same as the time between the last step of a current scan and the first step of a next scan for an actuator. This may ensure that time between any movement by the actuator is at a constant interval.

In some implementations, an actuator may move in a continuous, non-quantized constant motion to complete a scan. In other words, in some cases, a scan for an actuator may include a single scan step.

In some implementations, an actuator may move via angular or rotary travel. Accordingly, although the illustrative example above discusses XYZ travel, a system of actuators may move using other coordinate frames, such as cylindrical and/or spherical coordinate frames.

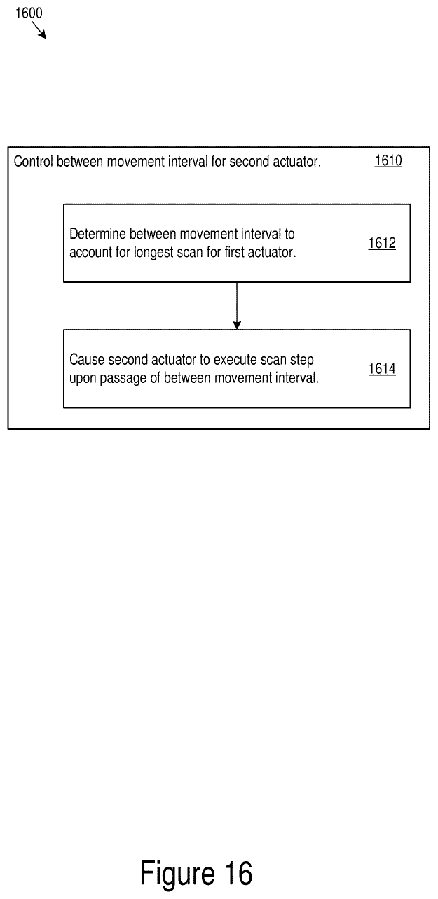

FIG. 16 shows example interval logic 1600. The interval logic 1600 may control movement timings for one or more actuators. To control the timings, the interval logic 1600 may control the between movement interval of a second actuator such that the second actuator executes a scan step after a first actuator completes a scan (1610). The interval logic 1600 may control the interval, but determining the between movement interval to account for the first actuator completing the longest scan that is to be used in the writing task (1612). The interval logic 1600 may cause the second actuator to perform a scan step upon passage of each interval until the optical writing task is complete (1614).

In some implementations, the interval logic 1600 may couple the timing of one actuator to the operation of another actuator. For example, the interval logic 1600 may enforce the interval by triggering the second actuator to move when the first actuator completes the scan and/or performs a predefined number of scan steps equivalent to a scan.

In some implementations, the interval logic 1600 may cause a first actuator to scan over regions of a write field where no voxels are to be written to ensure that the scan for the first actuator extends over an entire interval. If the scan completes early, the first actuator may sit dormant until an interval for another actuator completes and the first actuator may again be used in writing. Thus, the timing between the last step of the current scan and the first step of the next scan may be different than other intervals between scan steps for the first actuator. Scanning over a full scan travel may prevent such between-scan timing variance.

In some implementations, to avoid writing voxels otherwise altering regions where no voxels are to be written while scanning actuators over these regions, the illumination power from an illumination source may be set below a writing threshold. Various techniques for adjusting incident illumination power may be used. For example, light from the illumination source may be blocked, diverted, attenuated, or otherwise reduced. In some implementations the illumination source may be turned off and/or shifted out of a high power operation mode (e.g., an amplifier may be turned off and/or a laser may be shifted out of a mode-locked state). Other methods of reducing illumination power may be used. In some implementations, the stability of an illumination source may increase after an initial ‘warm up’ period, as discussed below. In some cases, techniques for reducing illumination power that disturb a ‘warmed up’ status of an illumination source may be avoided. For example, some laser sources dependent on a warm up for stable operation may not necessarily be turned off (or otherwise powered down) to bring illumination below the write threshold. In some cases, shifting a laser out of a mode-locked state may have a similarly disturbing effect on the warmed up state of the laser. Accordingly, a reduction technique that allows the laser to remain mode-locked may be used.

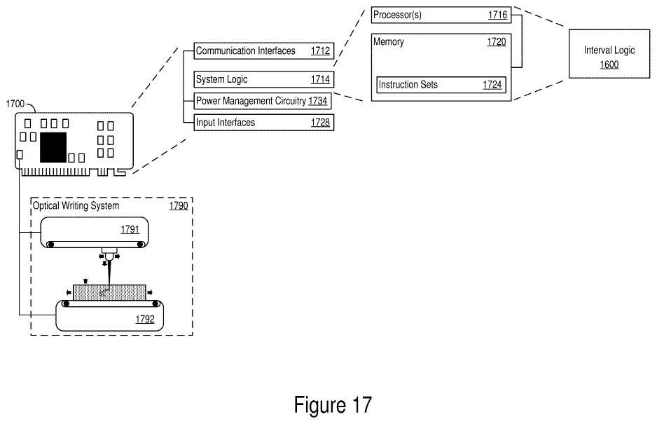

FIG. 17 shows example movement interval circuitry (MIC) 1700 control of between-movement intervals for actuators 1791, 1792 in an optical writing system 1790. The MIC 1700 may provide a hardware environment for execution of the interval logic 1600. The MIC 1700 may include system logic 1714 to support multi-actuator timing, interval determination, actuator triggering and/or interval enforcement. The system logic 1714 may include processors 1716, memory 1720, and/or other circuitry, which may be used to implement the example interval logic 1600.

The memory 1620 may be used to store the actuator instruction sets 1724. The memory 1720 may further include applications and structures, for example, coded objects, templates, or one or more other data structures to support multi-actuator timing, interval determination, actuator triggering and/or interval enforcement. The MIC 1700 may also include one or more communication interfaces 1712, which may support internal bus communications, wired/wireless data communication, and/or other operational input. The MIC 1700 may include power management circuitry 1734 and one or more input interfaces 1728 for operator input and/or other operational control.

The MIC 1700 may be coupled to an optical writing system 1790 for control of actuator interval timings. The optical writing system 1790 may include multiple actuators 1791, 1792, which may be operated such that between-movement intervals are held constant for the actuators.

### Position Correction Lookup

In various implementations, errors in motion consistency across the scan extent of actuators may lead to mismatch between where an actuator places a point on one side the scan of the actuator versus where the same point is placed when the actuator is on the other size of the scan. In some cases, where a multidimensional write field is generated by the scan extent of two or more actuators, errors may stack. Accordingly, points may be placed differently in one corner of a multidimensional write field than in another corner of the same multidimensional write field. Write fields may be written side by side to allow for optics larger (at least in one dimension) than the extent of a single write field. However, the side-by-side write fields may have a mismatch because opposite corners may be placed next to opposite corners. Accordingly, without correction, an optic may exhibit a stitching artifact at the border between neighboring write fields. Additionally, in various implementations, errors in motion may lead to mismatch between where an actuator places a point even within a single write field. Accordingly, without correction, an optic may exhibit a loss in shape fidelity between its designed shape and its written shape.

In some implementations, objects (vernier scales, concentric boxes, checker patterns, arrays of rectangles, arrays of ellipses, arrays of lines, arrays of other shapes, or other marking objects) may be written into a scaffold at the different corners of the write field. In some implementations, objects (vernier scales, concentric boxes, checker patterns, arrays of rectangles, arrays of ellipses, arrays of lines, arrays of other shapes, or other marking objects) may be written into a scaffold at specified locations within the write field. The written objects may be analyzed, e.g., via a microscopy analysis to determine coordinate corrections for such stitching errors at each corner and for loss of shape fidelity within the write field. Thus, the placement of points may be corrected by writing at a corrected location that accounts for the positioning error.

However, correcting for stitching error or for shape fidelity may cause spacing type positioning errors. For example, correcting a position by a few microns (or other unit of distance) may lead to objects in neighboring write fields or within the same write field being slightly closer to (or slightly farther away from) one another than may be indicated from their absolute coordinates. Thus, when the stitching or shape fidelity correction is applied, a second absolute distance correction may be applied. The absolute distance correction may be determined by measuring distances between the analyzed corrections markings in the various corners of the write field made for correction of stitching error and in various locations within the write field made for correction of shape fidelity error above.

Correcting for absolute distance while correcting for stitching error may correct for alignment between write fields and avoid errors in absolute distance (e.g., error from correcting the alignment by slightly overlapping the coordinates of the write field). Correcting for shape fidelity is important when correcting for stitching error. For example, without shape fidelity correction, the motion of the actuators may have misaligned derivatives at the different corners. In other words, the error in intended motion for neighboring write fields may point in different directions. Accordingly, waveguides crossing into different write fields may exhibit kinks. In long written lines, this deflection error may be observed as a slight bend in the waveguide. This deflection may be corrected by measuring curvature in the concentric boxes and/or Vernier markings. In some cases, extended lines or arrays of marking objects at specified locations within the write field may be written to characterize such deflection error and its dependence on position.

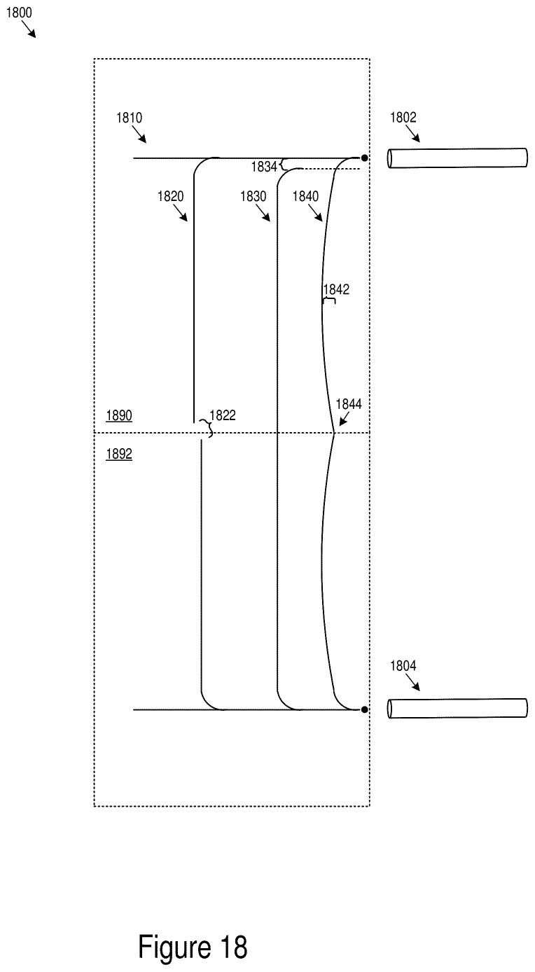

FIG. 18 shows an illustrative example set of written objects 1810 written across two write fields 1890, 1892 in a porous scaffold 1800. Two external waveguides 1802 and 1804 couple to the porous scaffold. The illustrative example set of written objects 1810 includes a waveguide 1820 with a stitching error 1822, a waveguide 1830 with a corrected stitching error 1832 and absolute distance error 1834, and a waveguide 1840 with a shape fidelity deflection error 1842 and a kink 1844. In the illustrative example, the two external waveguides 1812 and 1814 have a predetermined separation that is greater than the extent of the write field of the optical system used to create the written objects 1810. Accordingly, in some cases, the writing process may include stitching together two write fields to generate a written device that may couple to both external waveguides 1812, 1814.

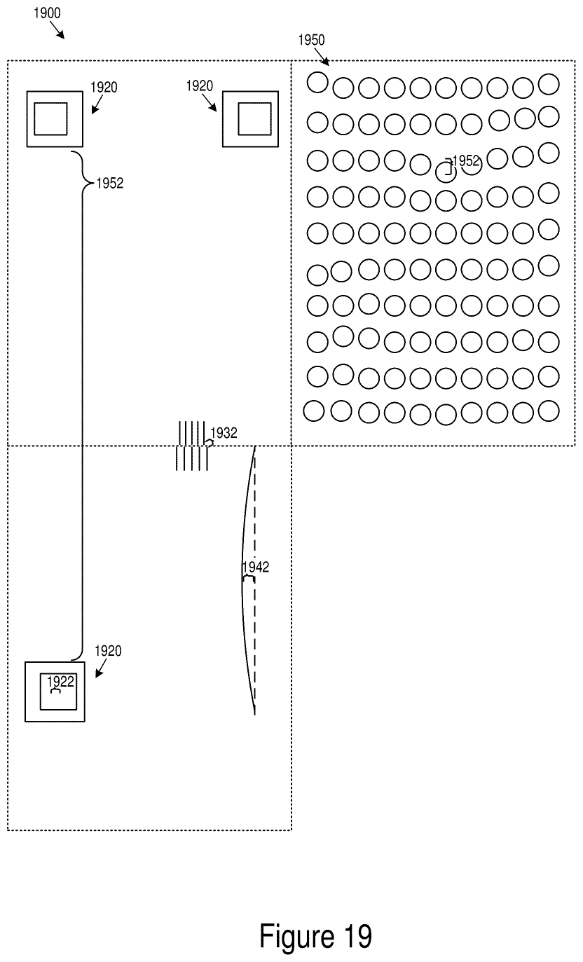

FIG. 19 shows an illustrative example set of analysis objects 1910 in a porous scaffold 1900. The analysis objects include concentric boxes 1920, a Vernier scale 1930, and extended lines 1940. Stitching errors may be characterized by analysis the off-centering 1922 in the concentric boxes 1920 and/or the misalignment 1932 of the Vernier scale 1930 hashes across neighboring write fields. Absolute distance errors may be measured by measuring distances 1952 between objects in different regions of the write field and ensuring that coordinates on the written scaffold match to one another after initial correction for stitch misalignment. The motion derivatives for the various actuators may be characterized by measuring deflection 1942 in the extended lines 1940. Shape fidelity may be characterized by measuring the off-centering 1952 of individual circles within an array 1950 written to have uniform spacing.

A correction matrix may be generated based on the determined stich error, absolute distance error, and shape fidelity errors. In the preferred embodiment, an adjusted position data structure may be generated for quick lookup and to enable nonlinear corrections to be made. The correction matrix or the adjusted position data structure for the write field may ensure that all regions of the write field are transformed such that voxels intended for writing at a selected point in physical space are transformed into an accurate position adjusted point in “actuator motion’ space. This may result in all regions of a write field being written in consistent physical space coordinates such that neighboring write fields as well as single write fields have physical space continuity.

In some cases, the adjusted position data structure may include the correction matrix in lieu of stored transformed results. Accordingly, the lookup operation may include obtaining the matrix values and applying the matrix to the selected location to generate the corresponding position-adjusted point.

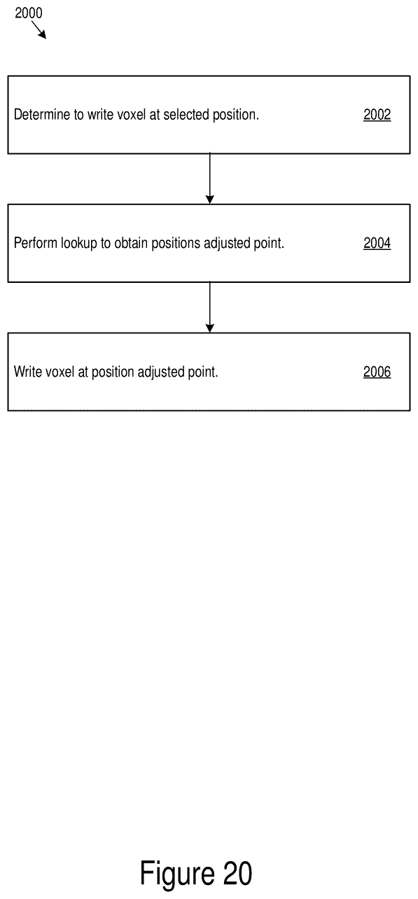

FIG. 20 shows example position control logic 2000. The example position control logic 2000 may determine to write a voxel at a selected point within a write field (2002). The selected point may include a point specified in physical space (e.g., the coordinate system of the porous scaffold being written). However, the coordinate system of the write field may include actuator motion space. Accordingly, the position control logic 2000 may transform the selected point in physical space into a position-adjusted point for actuator motion space.

The example position control logic 2000 may use the selected point to perform a lookup to obtain the position adjusted point for the write field (2004). Rather than writing the voxel at the selected location, the position control logic 2000 may cause the optical writing system to write the voxel at the position adjusted point in the write field (2006). The resultant voxel may then be properly located withing the physical space of the porous scaffold.

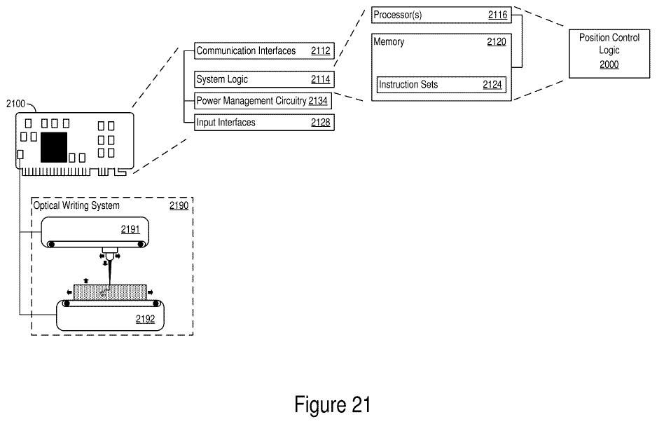

FIG. 21 shows example position control circuitry (PCC) 2100 for correction of position errors due to actuator motion. The PCC 2100 may provide a hardware environment for execution of the position control logic 2000. The PCC 2100 may include system logic 2114 to support position lookup, matrix transformation, actuator positioning, and/or data structure generation. The system logic 2114 may include processors 2116, memory 2120, and/or other circuitry, which may be used to implement the example interval logic 2000.

The memory 2120 may be used to store the actuator instruction sets 2124. The memory 2120 may further include applications and structures, for example, coded objects, templates, or one or more other data structures to support position lookup, matrix transformation, actuator positioning, and/or data structure generation. The PCC 2100 may also include one or more communication interfaces 2112, which may support internal bus communications, wired/wireless data communication, and/or other operational input. The PCC 2100 may include power management circuitry 2134 and one or more input interfaces 2128 for operator input and/or other operational control.

The PCC 2100 may be coupled to an optical writing system 2190 for control of actuator positioning. The optical writing system 2190 may include multiple actuators 2191, 2192, which may be operated such that transformed actuator coordinates are used to generate voxels properly positioned in physical space.

### Seam Smoothing

In some implementations, in addition or alternatively to positional errors, seams may be present at write field borders because writing stops for one write field and begins for the other at the border. In some implementations, even when positional errors are fully corrected, seams may be present at write field borders due to the difference in time interval between writing adjacent voxels within a single write field and writing adjacent voxels that cross the boundary between two write fields. The seams may generate loss, e.g., due to reflections, loss of optical confinement, and/or other loss mechanisms. In some implementations, seams may be corrected by applying multi-pass writing (e.g., using MOWL 1300 and/or dither logic 1500) using a third actuator to shift the write field of another group of actuators and then performing an additional writing pass. Successively shifting the write-field border and performing additional writing passes smoothens the seam, e.g., via a dither process. The seam may be corrected using writing passes originating from one side of the border or from both sides of the border. For the passes, reduced illumination output from the illumination source of the optical writing system may be used such that the desired optical contrast for the written optic is achieved after multiple passes rather than in a single pass.

### Illumination Source Warm Up

In some implementations, an illumination source may exhibit increased stability over time periods used in optical writing tasks after an initial warm up period. For example, writing fidelity (e.g., the resultant quality of the written optics) of an optical writing system may increase when the illumination source has been in an ‘on’ or ‘standby’ state for hours, days, weeks (or more in some cases). Accordingly, in some implementations, the illumination source may be allowed to warm up for at least a predefined period before usage.

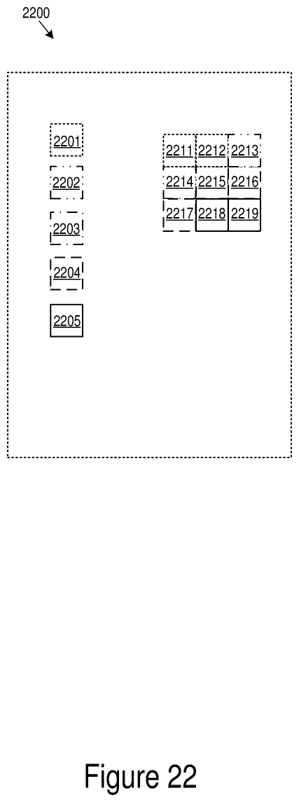

In some implementations, quality indicators may be written on to a porous scaffold to demonstrate, e.g., for quality assurance and/or before investing time to write optics, that sufficient power stability has been achieved prior to writing. For example, multiple arrays of voxels at different illumination power levels may be written. FIG. 22 shows an example porous scaffold with multiple arrays of voxels written 2201-2205, 2211-2219. The first set of arrays 2201-2205 are organized in a row showing decreasing illumination power. In some implementations, the middle array 2203 may be designed to be written at a power slightly above the writing threshold power for a properly stabilized system while the array 2204 may be designed to be written at a power slightly below the writing threshold power for a properly stabilized system. When the arrays 2201 and 2202 are fully visible, array 2203 is slightly visible, and arrays 2204 and 2205 are not visible, it may be determined that power stability has been reached. The presence of a array 2204 or 2205 or the absence of arrays 2201, 2202, or 2203 may indicate that quality targets for the written optics within the porous scaffold had not been met.

Additionally or alternatively, the power of the illumination source may be adjusted and arrays 2201-2205 be written at other locations within the write field or in an adjacent write field. This process may be repeated until the visibility criteria is met. This process enables the writing of the optic to commence in a time shorter than the full warm up period. To minimize the deleterious impacts of drift in the illumination power when writing one or more optics, the arrays 2201-2205 may be written and checked for visibility and for determining the necessary adjustments to the illumination power in real time. To minimize the effects of spatial variation in the illumination source, the arrays 2201-2205 may be written at specific locations within a write field and the degree of visibility be measured to determine power adjustments as a function of spatial location and as a function of desired set power. The measured data may be stored in a visibility data structure.

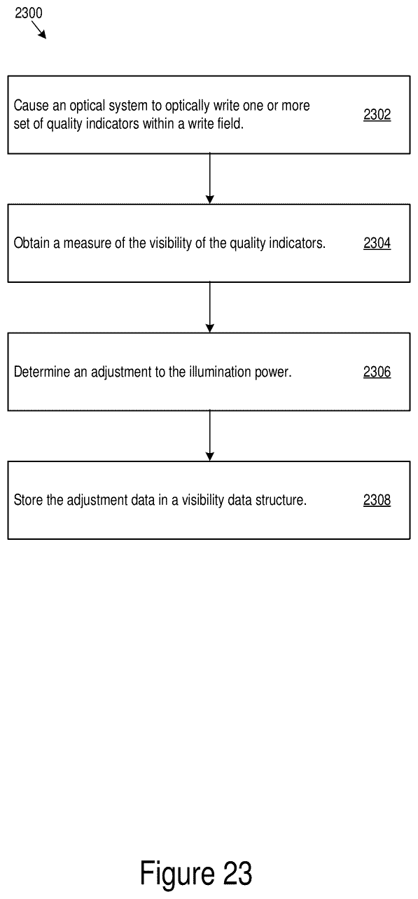

FIG. 23 shows example visibility criteria logic 2300. The example visibility criteria logic may cause an optical writing system to optically write one or more sets of quality indicators within a write field (2302). The visibility criteria logic 2300 may obtain a measure of the visibility of the set of indicators (2304). The visibility criteria logic 2300 may determine in response to the measured visibility data, an adjustment to the illumination power for writing a subsequent voxel (2306). The visibility criteria logic 2300 may store the adjustment data in a visibility data structure (2308).

The visibility data structure may be used with the illumination logic 1100 as an adjusted power data structure. Thus, the illumination logic 1100 may additionally or alternatively account for changes in illumination power determined via the visibility criteria.

Referring again to FIG. 22, the second set of arrays 2211-2219 are organized in a three-by-three grid. Such organization may provide concentric boxes because center array 2215 is concentric with the box formed by the outer border of the other eight arrays. Accordingly, such a set of arrays 2211-2219 may also be used for positional error characterization in addition to characterization of illumination source stability. In some implementations, the quality indicators may be inspected in situ (e.g., with an optical inspection microscope) by the optical writing system thereby allowing the illumination source to remain in ‘on’ or ‘standby’ state.

The various logics described above may be readily grouped and/or combined to control operation of optical writing system with multi-session writing capability, multi-pass writing capability, dither capability, bend computation capability, power adjustment capability, shape fidelity correction capability, and/or other functionalities described herein.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

The present disclosure has been described with reference to specific examples that are intended to be illustrative only and not to be limiting of the disclosure. Changes, additions and/or deletions may be made to the examples without departing from the spirit and scope of the disclosure. Various implementations have been described various implementations are possible. Table 1 includes various examples.

TABLE 1
Examples

1. A device including:
a porous scaffold characterized by a scaffold refractive index;
an optically written optic embedded in the porous scaffold; and
a coating forming a surface of the porous scaffold, the coating including:
the surface characterized by a surface refractive index; and
a transition region characterized by a refractive index gradient that transitions
between the surface refractive index and the scaffold refractive index,
where:
optionally, this example is in accord with or combined with any other example
or group of examples in this table.
2. The device, system, method, or product of any other example in this table,
where the coating includes a coating material, the coating material diffused into
the transition region to form the refractive index gradient.
3. The device, system, method, or product of any other example in this table,
where the refractive index gradient corresponds to a diffusion profile of the coating
material generated by diffusing the coating material into the porous scaffold.
4. The device, system, method, or product of any other example in this table,
where the scaffold refractive index includes a refractive index between an ambient
refractive index and a refractive index of a scaffold material of the porous scaffold.
5. The device, system, method, or product of any other example in this table,
where the surface refractive index includes a refractive index matched to a
refractive index of a semiconductor material, and/or a refractive index of silica.
6. The device, system, method, or product of any other example in this table,
where the coating includes a coating material deposited on to the scaffold via a
low-temperature and/or room temperature deposition process.
7. The device, system, method, or product of any other example in this table,
where the coating includes multiple materials in combination to effect the refractive
index gradient.
8. The device, system, method, or product of any other example in this table,
where the multiple materials include multiple materials applied in layers to the
porous scaffold.
9. The device, system, method, or product of any other example in this table,
where the multiple materials include an optical fluid and/or a material deposited
via a carrier gas.
10. The device, system, method, or product of any other example in this table,
where each of the multiple materials include a member of the SiNx system.
11. The device, system, method, or product of any other example in this table,
where the members of the SiNx system are characterized by a progression of
indices spanning from a refractive index of a semiconductor material to a refractive
index of a coupling fiber material.
12. The device, system, method, or product of any other example in this table,
where the optically written optic includes coupler to couple one or more fiber ports
to one or more on-chip ports.
13. A method including:
for a porous scaffold characterized by a scaffold refractive index including an
optically written optic embedded in the porous scaffold:
applying a coating forming to a surface of the porous scaffold, the coating
including:
the surface characterized by a surface refractive index; and
a transition region characterized by a refractive index gradient that
transitions between the surface refractive index and the scaffold
refractive index, where:
optionally, this example is in accord with or combined with any other
example or group of examples in this table.
14. The device, system, method, or product of any other example in this table,
where applying the coating includes diffusing a material of the coating into the
porous scaffold.
15. The device, system, method, or product of any other example in this table,
where applying the coating includes performing a layered deposition of the coating
onto the porous scaffold.
16. The device, system, method, or product of any other example in this table,
where applying the coating includes varying an electrochemical etch current
density to vary a pore size across a thickness of the coating.
17. The device, system, method, or product of any other example in this table,
where applying the coating includes varying a silicon content of the coating across
a thickness of the coating.
18. A device including:
a porous scaffold; and
a coating forming a surface of the porous scaffold, the coating including:
the surface characterized by a surface refractive index; and
a transition region diffused into the porous scaffold, the transition region
characterized by a refractive index gradient that transitions between the
surface refractive index and a scaffold refractive index that characterizes
an internal volume of the porous scaffold, where:
optionally, this example is in accord with or combined with any other example
or group of examples in this table.
19. The device, system, method, or product of any other example in this table,
where the porous scaffold includes an optically written optic embedded within the
internal volume.
20. The device, system, method, or product of any other example in this table,
where the refractive index gradient corresponds to a diffusion profile of a coating
material generated by diffusing the coating material into the porous scaffold.
21. A device including:
an optically-written waveguide embedded in a porous scaffold; and
an optically-written coupler optic on and/or embedded within the porous
scaffold, the optically-written coupler optic proximate to an end of the
optically-written waveguide, where:
optionally, this example is in accord with or combined with any other example or
group of examples in this table.
22. The device, system, method, or product of any other example in this table,
where the coupler optic includes a ball-shaped optic.
23. The device, system, method, or product of any other example in this table,
where the ball-shaped optic varies in refractive index along a radius of the ball-
shaped optic.
24. The device, system, method, or product of any other example in this table,
where ball-shaped optic has a highest refractive index at a center of the ball-
shaped optic.
25. The device, system, method, or product of any other example in this table,
where the ball-shaped optic varies in refractive index along a radius of the ball-
shaped optic by having a step-index change at a point along the radius of the ball-
shaped optic.
26. The device, system, method, or product of any other example in this table,
where the ball shaped optic includes a Luneburg lens.
27. The device, system, method, or product of any other example in this table,
where the optically-written waveguide includes a taper at the end proximate to the
coupler optic.
28. The device, system, method, or product of any other example in this table,
where the coupler optic includes voxels written in at least two writing sessions,
including:
a superset writing session covering a first exposed region; and
a subset writing session including a second exposed region within the first exposed
region, the first region including at least a third exposed region not within the
second exposed region.
29. A method including:
optically-writing a coupler optic for a waveguide within a porous scaffold by:
performing a superset writing session covering a first exposed region of the
coupler optic within the porous scaffold; and
performing a subset writing session including a second exposed region within
the first exposed region, the first region including at least a third exposed
region not within the second exposed region, such that the second exposed
region is exposed for voxel writing in both the superset writing session and
subset writing session, where:
optionally, this example is in accord with or combined with any other example
or group of examples in this table.
30. The device, system, method, or product of any other example in this table,
where the method includes performing the superset writing session prior to the
subset writing session.
31. The device, system, method, or product of any other example in this table,
where the method includes performing the subset writing session prior to the
superset writing session.
32. The device, system, method, or product of any other example in this table,
where the performing a superset writing session and performing a subset writing
session causes a step-index difference in refractive index between a portion of the
coupler optic within the second region and a portion of the coupler optic within the
third region.
33. The device, system, method, or product of any other example in this table,
where:
the first exposed region includes a ball-shaped region;
the second exposed region includes a ball-shaped region concentric with the first
exposed region, the second exposed region smaller than the first exposed region.
34. The device, system, method, or product of any other example in this table,
further including one or more additional subset sessions with corresponding
exposed regions within the second region to approximate a continuous index
change through successive step-index changes.
35. The device, system, method, or product of any other example in this table,
where:
all the exposed regions are ball shaped and concentric; and
the coupler includes a Luneburg lens approximated using multiple step-index
refractive index transitions.
36. A method including:
optically-writing an optic within a porous scaffold by:
performing a first writing session covering a first exposed region of the optic
within the porous scaffold; and
performing a second writing session including a second exposed region, the
first region including at least a third exposed region not within the second
exposed region, such that at least a portion of the second exposed region
is exposed for voxel writing in both the first writing session and second
writing session, where:
optionally, this example is in accord with or combined with any other example
or group of examples in this table.
37. The device, system, method, or product of any other example in this table,
where the method includes completing the first writing session prior to initiating the
second writing session.
38. The device, system, method, or product of any other example in this table,
where the second region is at least partially outside the first region.
39. The device, system, method, or product of any other example in this table,
where:
the first writing session includes a superset session; and
the second writing session includes a subset session.
40. The device, system, method, or product of any other example in this table,
where the optic includes a waveguide, an end coupler, a lens, and/or an optical
resonator.
41. A method including:
obtaining a first selected cross section for a first portion of a waveguide to be written
in a porous scaffold, the first portion aligned along a first axis;
obtaining a second selected cross section for a second portion of the waveguide to
be written in the porous scaffold, the second portion of aligned along a second axis
different from the first axis;
determining a bend connecting the first portion to the second portion;
determining, based the first selected cross section and the second selected cross
section, a set of transition cross sections that map to a transformation from the first
cross section to the second cross section;
determining corresponding orientations for each of the individual ones of the set of
transition cross sections to orient the transition cross sections along the bend; and
optically writing a first group of voxels in the porous scaffold along the first axis and
consistent with the first selected cross section, to write the first portion in the
porous scaffold;
optically a second group of voxels in the porous scaffold along the second axis and
consistent with the second selected cross section, to write the second portion in
the scaffold; and
optically writing a third group of voxels between the first portion and the second
portion, the third group of voxels consistent with the bend, the set of transition
cross sections, and the corresponding orientations, where:
optionally, this example is in accord with or combined with any other example or
group of examples in this table.
42. The device, system, method, or product of any other example in this table,
where:
the porous scaffold is configured to couple to an external waveguide from a face of
the scaffold;
optically writing the first group of voxels along the first axis includes writing the first
group of voxels along an axis perpendicular to the face of the scaffold; and
optically writing the second group of voxels along the second axis includes writing
the second group of voxels along an axis parallel to the face of the scaffold.
43. The device, system, method, or product of any other example in this table,
where the external waveguide includes an optical fiber and/or a waveguide within
a semiconductor wafer.
44. The device, system, method, or product of any other example in this table,
where:
the porous scaffold is configured to couple to an external waveguide from a face of
the scaffold;
optically writing the first group of voxels along the first axis includes writing the first
group of voxels along an axis parallel to the face of the scaffold; and
optically writing the second group of voxels along the second axis includes writing
the second group of voxels along an axis parallel to the face of the scaffold.
45. The device, system, method, or product of any other example in this table,
where the bend traces a circular arc.
46. The device, system, method, or product of any other example in this table,
where the bend traces a Bezier curve.
47. The device, system, method, or product of any other example in this table,
where the bend traces a 90-degree turn.
48. The device, system, method, or product of any other example in this table,
where:
the first selected cross section includes a rectangular cross section and/or an
elliptical cross section; and
the second selected cross section includes a rectangular cross section and/or an
elliptical cross section.
49. The device, system, method, or product of any other example in this table,
where writing the first group of voxels further includes optically writing an end
coupler spaced away from an end of the first portion opposite an end of the first
portion connected to the third group of voxels.
50. A waveguide optically written into a porous scaffold, the waveguide including:
a first portion, the first portion having a first selected cross section, the first portion
aligned along a first axis within the porous scaffold;
a second portion, the second portion having a first selected cross section, the
second portion aligned along a second axis within the porous scaffold, the second
axis different from the first axis; and
a bend that couples the first portion to the second portion, the bend characterized
by a set of transition cross sections that map to a transformation from the first
cross section to the second cross section, where:
optionally, this example is in accord with or combined with any other example or
group of examples in this table.
51. The device, system, method, or product of any other example in this table,
where:
the porous scaffold is configured to couple to an external waveguide from a face of
the scaffold;
the first axis includes an axis perpendicular to the face of the scaffold; and
the second axis includes an axis parallel to the face of the scaffold.
52. The device, system, method, or product of any other example in this table,
where the external waveguide includes an optical fiber and/or a waveguide within
a semiconductor wafer.
53. The device, method, or product of any other example in this table, where the
bend traces a circular arc.
54. The device, system, method, or product of any other example in this table,
where the bend traces a Bezier curve.
55. The device, system, method, or product of any other example in this table,
where the bend traces a 90-degree turn.
56. The device, system, method, or product of any other example in this table,
where:
the first selected cross section includes a rectangular cross section and/or an
elliptical cross section; and
the second selected cross section includes a rectangular cross section and/or an
elliptical cross section.
57. The device, system, method, or product of any other example in this table,
where the porous scaffold further includes an end coupler spaced away from an
end of the first portion opposite an end of the first portion connected to the bend.
58. A method including:
optically writing a first group of voxels to generate a first-axis cross section to write
a first portion of a waveguide that allows light to propagate along a first axis within
a porous scaffold;
determining to write a bend into the waveguide such that a second portion of the
waveguide allows light to propagate along a second axis different from the first;
determining a second-axis cross section corresponding to the second portion;
determining a set of transition cross sections mapping to a transformation from the
first cross section to the second cross section;
determining a location for a start of the second portion; and
optically writing a second group of voxels into the porous scaffold to generate the
set of transition cross sections to form a bend portion of the waveguide between
an end of the first portion of the waveguide and the start of the second portion of
the waveguide, where:
optionally, this example is in accord with or combined with any other example or
group of examples in this table.
59. The device, system, method, or product of any other example in this table,
where:
optically writing along the first axis includes writing along an axis parallel to a
propagation direction; and
optically writing the second axis includes writing along an axis perpendicular to a
propagation direction.
60. The device, system, method, or product of any other example in this table,
where:
generating the first-axis cross section includes writing an elliptical cross section
transverse to the propagation direction of the writing laser; and
generating the second-axis cross section includes writing a rectangular cross
section one voxel in height parallel to the propagation direction of the writing laser.
61. A method including:
determining to optically write a voxel at a selected point within a write field at a
selected effective power;
using the selected point and the selected effective power performing a lookup in an
adjusted power data structure;
obtaining, in response to the lookup and from the adjusted power data structure, an
adjusted power at which to set a writing illumination source to illuminate the
selected point at the selected effective power; and
optically writing the voxel at the selected point with the writing illumination source
set at the adjusted power, where:
optionally, this example is in accord with or combined with any other example or
group of examples in this table.
62. The device, system, method, or product of any other example in this table,
where optically writing the voxel includes optically writing the voxel in a porous
scaffold positioned at least in part within the write field.
63. The device, system, method, or product of any other example in this table,
where the adjusted power data structure includes a power adjustment entry for
each of a set of points within the write field.
64. The device, system, method, or product of any other example in this table,
where the adjusted power data structure includes multiple power adjustment
entries for each of the set of points within the write field, the multiple entries
defining a power-level dependent adjustment scheme.
65. The device, system, method, or product of any other example in this table,
where the write field includes points accessible via motion of a first actuator.
66. The device, system, method, or product of any other example in this table,
where:
points accessible only through motion of actuators other than the first actuator are
outside the write field; and
the write field includes a one-dimensional write field.
67. The device, system, method, or product of any other example in this table,
where the write field includes points accessible via motion of a second actuator.
68. The device, system, method, or product of any other example in this table,
where:
points accessible only through motion of actuators other than the first actuator and
second actuator are outside the write field; and
the write field includes a two-dimensional write field.
69. The device, system, method, or product of any other example in this table,
where the first actuator includes a piezoelectric actuator, a translation stage, a
spot-focus-moving actuator, and/or a scaffold-moving actuator.
70. The device, system, method, or product of any other example in this table,
where the adjusted power data structure is populated using data generated by
writing voxels at each point in the write field at a first test power.
71. The device, system, method, or product of any other example in this table,
where the adjusted power data structure is populated using data collected from an
image, where the image includes a fluorescence intensity image, a brightfield
image, a darkfield image, and/or a confocal image.
72. A system including:
an illumination source configured to illuminate points within a write field;
memory configured to store an adjusted power data structure specific to the
illumination source and the write field;
illumination control circuitry configured to:
obtain an instruction to optically write a voxel at a selected point within the
write field at a selected effective power;
access the memory to perform, using the selected point and the selected
effective power, a lookup in the adjusted power data structure;
obtain, in response to the lookup, an adjusted power at which to set the
illumination source to illuminate the selected point at the selected effective
power; and
cause the illumination source to illuminate the selected point while operating
at the adjusted power, where:
optionally, this example is in accord with or combined with any other example
or group of examples in this table.
73. The device, system, method, or product of any other example in this table,
where the adjusted power data structure includes a power adjustment entry for
each of a set of points within the write field.
74. The device, system, method, or product of any other example in this table,
where the adjusted power data structure includes multiple power adjustment
entries for each of the set of points within the write field, the multiple entries
defining a power-level dependent adjustment scheme.
75. The device, system, method, or product of any other example in this table,
where:
the system further includes an actuator; and
the write field includes points accessible via motion of the actuator.
76. The device, system, method, or product of any other example in this table,
where the selected effective power is determined based on a selected refractive
index at which the voxel is to be written.
77. The device, system, method, or product of any other example in this table,
where the illumination control circuitry is further configured to access the memory
to perform the lookup based on an actuator dwell time to determine an exposure
associated with the selected effective power.
78. A product including:
machine-readable media other than a transitory signal; and
instructions stored on the machine-readable media, the instructions configured to,
when executed, cause a processor to:
determine to optically write a voxel at a selected point within a write field at a
selected effective power;
perform, using the selected point and the selected effective power, a lookup in
an adjusted power data structure;
obtain, in response to the lookup and from the adjusted power data structure, an
adjusted power at which to set a writing illumination source to illuminate the
selected point at the selected effective power; and
cause an writing illumination source to optically write the voxel at the selected
point with the writing illumination source set at the adjusted power, where:
optionally, this example is in accord with or combined with any other example or
group of examples in this table.
79. The device, system, method, or product of any other example in this table,
where the adjusted power data structure is populated using data generated by
writing voxels at each point in the write field at a first test power.
80. The device, system, method, or product of any other example in this table,
where the adjusted power data structure is further populated by repeating for
multiple test powers representative of the power range used in the writing of
various optics.
81. A method including:
for an optical writing system with a first actuator of a first type and a second actuator
of a second type, the second type different from the first:
determining to write a first group of voxels into a porous scaffold by
performing a writing pass over a write field using at least the first actuator;
after completing the writing pass over the write field, executing a move using
the second actuator;
compensating for the move using an actuator other than the second actuator;
and
executing, using at least the first actuator, a second writing pass over the
write field to write a second group of voxels that overlaps with the first group,
the first group written with the second actuator at a different position from
that while writing the second group, where:
optionally, this example is in accord with or combined with any other example
or group of examples in this table.
82. The device, system, method, or product of any other example in this table,
where:
the first type includes an actuator type for moving a spot focus of the optical writing
system; and
the second type includes an actuator type for moving the porous scaffold.
83. The device, system, method, or product of any other example in this table,
where compensating for the move using an actuator other than the second
actuator includes compensating for the move using at least the first actuator.
84. The device, system, method, or product of any other example in this table,
where compensating for the move using an actuator other than the second
actuator includes compensating for the move using at least an actuator of the first
type.
85. The device, system, method, or product of any other example in this table,
where:
the move shifts a position of the write field; and
compensating for the move includes determining shifted positions of the first voxels
within the write field after the move; and
executing the second writing pass over the write field includes writing the second
group of voxels at the shifted positions.
86. The device, system, method, or product of any other example in this table,
where the first group of voxels and the second group of voxels differ in location by
a positioning error of the first actuator and/or second actuator.
87. The device, system, method, or product of any other example in this table,
where:
the first type includes piezo actuator type; and
the second type includes galvanometer actuator type.
88. The device, system, method, or product of any other example in this table,
where the second writing pass smoothens an artifact present in the first group of
voxels caused by a motion error of the first actuator and/or the second actuator.
89. The device, system, method, or product of any other example in this table,
where the first group of voxels form: an end coupler, a waveguide, and/or a bend
within a waveguide.
90. An optical writing system including:
a first actuator;
a second actuator different from the first actuator; and
actuator control circuitry configured to:
execute, using at least the first actuator, a first writing pass over a write field
to write a first group of voxels into a porous scaffold;
after completing the writing pass over the write field, execute a move using
the second actuator;
compensate for the move using an actuator of the optical writing system other
than the second actuator; and
execute, using at least the first actuator, a second writing pass over the write
field to write a second group of voxels that overlaps with the first group, the
first group written with the second actuator at a different position from that
while writing the second group, where:
optionally, this example is in accord with or combined with any other example
or group of examples in this table.
91. The device, system, method, or product of any other example in this table,
where:
the first type includes an actuator type for moving a spot focus of the optical writing
system; and
the second type includes an actuator type for moving the porous scaffold.
92. The device, system, method, or product of any other example in this table,
where the actuator control circuitry is configured to compensate for the move using
at least the first actuator.
93. The device, system, method, or product of any other example in this table,
where:
the optical writing system further includes a third actuator, the third actuator having
the first type; and
the actuator control circuitry is configured to compensate for the move using at least
the third actuator.
94. The device, system, method, or product of any other example in this table,
where:
the move shifts a position of the write field; and
the optical writing system is further configured to compensate for the move by
determining shifted positions of the first voxels within the write field after the move;
and
the optical writing system is further configured to execute the second writing pass
over the write field by writing the second group of voxels at the shifted positions.
95. The device, system, method, or product of any other example in this table,
where the first group of voxels and the second group of voxels differ in location by
a positioning error of the first actuator and/or second actuator.
96. The device, system, method, or product of any other example in this table,
where:
the first type includes linear-translation-stage actuator type; and
the second type includes galvanometer actuator type.
97. A method including:
determining to write a first group of voxels into a porous scaffold by performing a
writing pass over a write field using at least a first actuator;
executing a second writing pass over the write field to write a second group of voxels
that at least partially overlaps with the first group, where:
optionally, this example is in accord with or combined with any other example or
group of examples in this table.
98. The device, system, method, or product of any other example in this table,
where the second writing pass increases a refractive index contrast of at least a
portion of an optic written using the first group of voxels.
99. The device, system, method, or product of any other example in this table,
where the optic includes an end coupler, a waveguide, and/or a bend within a
waveguide.
100. The device, system, method, or product of any other example in this table,
where the second writing pass smoothens an artifact present in the first group of
voxels caused by a motion error of the first actuator and/or the second actuator.
101. A method including:
for a multiple actuator optical writing system:
controlling an interval between movements of a second actuator by executing
scans of a first actuator;
determining that no voxels are to be written in a portion of a write field covered
by continuation of a current scan of the first actuator; and
in lieu of ceasing the current scan of the first actuator to cause an immediate
movement of the second actuator, continuing the current scan of the first
actuator over the portion of a write field in which no voxels are to be written
to maintain the interval between movements at a constant duration, where:
optionally, this example is in accord with or combined with any other example
or group of examples in this table.
102. The device, system, method, or product of any other example in this table,
where a period between scan steps for the first actuator is constant.
103. The device, system, method, or product of any other example in this table,
where controlling the interval includes:
determining the number of scan steps used in a traversal of a full scan travel
extent of the first actuator; and
determining the interval based on the number and the period.
104. The device, system, method, or product of any other example in this table,
where the period is determined based on a target illumination exposure level for
voxel writing.
105. The device, system, method, or product of any other example in this table,
where the period is determined based on allowing for scan travel for a third
actuator.
106. The device, system, method, or product of any other example in this table,
further including setting an illumination power from an illumination source below a
writing threshold while continuing the current scan of the first actuator over the
portion of a write field in which no voxels are to be written.
107. The device, system, method, or product of any other example in this table,
where setting an illumination power from the illumination source below the writing
threshold includes blocking illumination from the illumination source, diverting
illumination from the illumination source, attenuating illumination from the
illumination source, and/or powering down the illumination source.
108. An optical writing system including:
a first actuator configured to execute multiple scans;
a second actuator configured to execute a scan step after each of the multiple scans
by the first actuator; and
control circuitry configured to control an interval between scan steps of the second
actuator by:
determining the interval, the interval allowing for completion of a longest scan
used in a writing task for a first actuator; and
causing the second actuator to wait an entirety of the interval between scan
steps when the first actuator executes any scan for the writing task, where:
optionally, this example is in accord with or combined with any other example
or group of examples in this table.
109. The device, system, method, or product of any other example in this table,
where a period between scan steps for the first actuator is constant.
110. The device, system, method, or product of any other example in this table,
where the control circuitry configured to determine the interval by:
determining the number of scan steps used in a traversal of a full scan travel
extent of the first actuator; and
determining the interval based on the number and the period.
111. The device, system, method, or product of any other example in this table,
where the period is determined based on a target illumination exposure level for
voxel writing.
112. The device, system, method, or product of any other example in this table,
where the period is determined based on allowing for scan travel for a third
actuator.
113. The device, system, method, or product of any other example in this table,
where a shortest scan by the first actuator is equal in duration to the longest scan.
114. The device, system, method, or product of any other example in this table,
where the first actuator is configured to continue a scan after voxel writing for the
scan is complete to maintain a constant scan traversal period.
115. The device, system, method, or product of any other example in this table,
where:
the optical writing system further includes an illumination source; and
the control circuitry is configured to set illumination power from the illumination
source below a writing threshold when the second actuator scans over a portion
of a write field in which no voxels are to be written.
116. The device, system, method, or product of any other example in this table,
where the first actuator is configured to execute scans via non-quantized
continuous motion.
117. A product including:
machine-readable media other than a transitory signal; and
instructions stored on the machine-readable media, the instructions configured to,
when executed, cause a processor to:
for a multiple actuator optical writing system:
control an interval between movements of first actuator by executing
scans of a second actuator;
in lieu of ceasing a current scan of the second actuator to expedite
completion of an optical writing pass, continuing the current scan of
the second actuator over a portion of a write field in which no voxels
are to be written to maintain the interval between movements at a
constant duration, where:
optionally, this example is in accord with or combined with any other
example or group of examples in this table.
118. The device, system, method, or product of any other example in this table,
where a period between scan steps for the first actuator is constant.
119. The device, method, or product of any other example in this table, where the
instructions are further configured to cause the processor to control the interval by:
determining the number of scan steps used in a traversal of a full scan travel
extent of the first actuator; and
determining the interval based on the number and the period.
120. The device, system, method, or product of any other example in this table,
where the period is determined based on a target illumination exposure level for
voxel writing.
121. A method including:
determining to optically write a voxel at a selected point within a write field;
using the selected point, performing a lookup in an adjusted position data structure;
obtaining, in response to the lookup from the adjusted position data structure, a
position-adjusted point in the write field; and
optically writing the voxel at the position-adjusted point instead of the selected point,
where:
optionally, this example is in accord with or combined with any other example or
group of examples in this table.
122. The device, system, method, or product of any other example in this table,
where the adjusted position data structure is populated using data obtained by
measuring relative position errors for different portions of a write field.
123. The device, system, method, or product of any other example in this table,
where the adjusted position data structure is populated using data obtained by
measuring position variance present when writing the same patterns of voxels for
different combinations of actuator positions.
124. The device, system, method, or product of any other example in this table,
where the adjusted position data structure is populated using data obtained by:
measuring relative position differences for written objects at opposite extents of a
write field; and/or
measuring a distance between written objects at opposite extents of a write field;
and/or
measuring relative position differences for written objects at specified locations
throughout the region of a write field; and/or
measuring a distance between written objects at specified locations throughout the
region of a write field.
125. The device, system, method, or product of any other example in this table,
where the adjusted position data structure is populated using data obtained by:
attempting to write one or more sets of concentric nested boxes at different
points in a write field; and
measuring deviation from concentric positioning within the one or more sets.
126. The device, system, method, or product of any other example in this table,
where the adjusted position data structure is populated using data obtained by:
attempting to write one or more sets of Vernier alignment marks at different
points in a write field; and
measuring the amount of misalignment among different write field positions
using the Vernier scale.
127. The device, system, method, or product of any other example in this table 1,
where the adjusted position data structure is populated using data obtained by:
attempting to write one or more sets of a measurement object of a fixed shape
at different points in a write field;
measuring the amount of misalignment among different write field positions
using the object; and
measuring the degree of shape fidelity of each object.
128. The device, system, method, or product of any other example in this table,
where the adjusted position data structure includes an absolute distance
correction to maintain continuity across a span of a write field.
129. The device, system, method, or product of any other example in this table,
where the adjusted position data structure is populated using data from a
microscopy analysis of optical writing on a porous scaffold.
130. The device, system, method, or product of any other example in this table,
where:
the microscopy analysis includes a scanning electron microscope analysis; and
the optical writing includes optical writing on a surface of the porous scaffold.
131. An optical writing system including:
an actuator configured to position a spot-focus of an optical writing system; and
position control circuitry configured to:
obtain instructions to optically write a voxel at a selected point within a write
field;
perform, using the selected point, a lookup in an adjusted position data
structure;
obtain, in response to the lookup from the adjusted position data structure, a
position-adjusted point in the write field; and
cause the actuator to position the spot focus at the position-adjusted point to
write the voxel instead of the selected point, where:
optionally, this example is in accord with or combined with any other example
or group of examples in this table.
132. The device, system, method, or product of any other example in this table,
where the adjusted position data structure is populated using data obtained by
measuring relative position errors for different portions of a write field.
133. The device, system, method, or product of any other example in this table,
where the adjusted position data structure is populated using data obtained by
measuring position variance present when writing the same patterns of voxels for
different combinations of actuator positions.
134. The device, system, method, or product of any other example in this table,
where the adjusted position data structure is populated using data obtained via:
measurement of relative position differences for written objects at opposite extents
of a write field;
measurement of a distance between written objects at opposite extents of a write
field;
measuring relative position differences for written objects at specified locations
throughout the region of a write field; and/or
measuring a distance between written objects at specified locations throughout the
region of a write field.
135. The device, system, method, or product of any other example in this table,
where the adjusted position data structure is populated using data obtained via:
an attempt to write one or more sets of concentric nested boxes at different
points in a write field; and/or
measurement of deviation from concentric positioning within the one or more
sets.
136. A product including:
machine readable media other than a transitory signal; and
instructions stored on the machine readable media, the instructions configured to,
when executed, cause a processor to:
determine to optically write a voxel at a selected point within a write field;
perform, using the selected point, a lookup in an adjusted position data
structure;
obtain, in response to the lookup from the adjusted position data structure, a
position-adjusted point in the write field; and
cause an actuator of an optical writing system to move a spot focus of the
optical writing system to the position-adjusted point to optically write the
voxel at the position-adjusted point instead of the selected point, where:
optionally, this example is in accord with or combined with any other example
or group of examples in this table.
137. The device, system, method, or product of any other example in this table,
where the adjusted position data structure is populated by:
attempting to write one or more sets of a measurement object of a fixed shape
at different points in a write field;
measuring the amount of misalignment among different write field positions
using the object;
measuring the degree of shape fidelity of each object.
138. The device, system, method, or product of any other example in this table,
where the adjusted position data structure includes an absolute distance
correction to maintain continuity across a span of a write field.
139. The device, system, method, or product of any other example in this table,
where the adjusted position data structure is populated using data from a
microscopy analysis of optical writing on a porous scaffold.
140. The device, system, method, or product of any other example in this table,
where:
the microscopy analysis includes a scanning electron microscope analysis; and
the optical writing includes optical writing on a surface of the porous scaffold.
141. The device, system, method, or product of any other example in this table,
where the microscopy analysis is performed in-situ by the optical writing system.
142. A method including:
determining to optically write one or more sets of quality indicators within a write
field;
measuring the degree of visibility of the set of indicators;
obtaining, in response to the measured visibility data, a determination of whether
the illumination source has sufficiently stabilized to the desired illumination power;
and/or
obtaining, in response to the measured visibility data, an adjustment to the
illumination power for writing a subsequent voxel, where:
optionally, this example is in accord with or combined with any other example or
group of examples in this table.
143. The device, system, method, or product of any other example in this table,
where the visibility power data structure includes a power adjustment entry for
each of a set of points within the write field.
144. The device, system, method, or product of any other example in this table,
where the visibility power data structure includes multiple power adjustment
entries for each of the set of points within the write field, the multiple entries
defining a power-level dependent adjustment scheme.
145. A system including:
an illumination source configured to illuminate points within a write field;
memory configured to store a visibility data structure specific to the illumination
source;
illumination control circuitry configured to:
obtain an instruction to optically write a voxel at a selected point within the
write field at a selected power;
access the memory to perform, using the selected point and the selected
power, a lookup in the visibility power data structure;
obtain, in response to the lookup, an adjusted power at which to set the
illumination source to illuminate the selected point at the selected power;
and
cause the illumination source to illuminate the selected point while operating
at the adjusted power, where:
optionally, this example is in accord with or combined with any other example
or group of examples in this table.
146. The device, system, method, or product of any other example in this table,
where the visibility data structure includes a power adjustment entry for each of a
set of points within the write field.
147. The device, system, method, or product of any other example in this table,
where the visibility data structure includes multiple power adjustment entries for
each of the set of points within the write field, the multiple entries defining a power-
level dependent adjustment scheme.
148. A product including:
machine-readable media other than a transitory signal; and
instructions stored on the machine-readable media, the instructions configured to,
when executed, cause a processor to:
determine to optically write a voxel at a selected point within a write field at a
selected power;
perform, using the selected point and the selected power, a lookup in a visibility
data structure;
obtain, in response to the lookup and from the visibility data structure, an
adjusted power at which to set a writing illumination source to illuminate the
selected point at the selected power; and
cause a writing illumination source to optically write the voxel at the selected
point with the writing illumination source set at the adjusted power, where:
optionally, this example is in accord with or combined with any other example or
group of examples in this table.
150. The device, system, method, or product of any other example in this table,
where the visibility data structure is populated using data generated by writing
voxels at each point in the write field at a first test power.
151. The device, system, method, or product of any other example in this table,
where the visibility power data structure is further populated by repeating for
multiple test powers representative of the power range used in the writing of
various optics.

The foregoing description is given for clearness of understanding only, and no unnecessary limitations should be understood therefrom.

1. A device including:
a porous scaffold characterized by a scaffold refractive index;
an optically written optic embedded in the porous scaffold; and
a coating forming a surface of the porous scaffold, the coating including:
the surface characterized by a surface refractive index; and
a transition region characterized by a refractive index gradient that transitions between the surface refractive index and the scaffold refractive index.

2. The device of claim 1, where the coating includes a coating material, the coating material diffused into the transition region to form the refractive index gradient.

3. The device of claim 2, where the refractive index gradient corresponds to a diffusion profile of the coating material generated by diffusing the coating material into the porous scaffold.

4. The device of claim 1, where the scaffold refractive index includes a refractive index between an ambient refractive index and a refractive index of a scaffold material of the porous scaffold.

5. The device of claim 1, where the surface refractive index includes a refractive index matched to a refractive index of a semiconductor material, and/or a refractive index of silica.

6. The device of claim 1, where the coating includes a coating material deposited on to the scaffold via a low-temperature and/or room temperature deposition process.

7. The device of claim 1, where the coating includes multiple materials in combination to effect the refractive index gradient.

8.-11. (canceled)

12. The device of claim 1, where the optically written optic includes coupler to couple one or more fiber ports to one or more on-chip ports.

13.-17. (canceled)

18. A device including:
a porous scaffold; and
a coating forming a surface of the porous scaffold, the coating including:
the surface characterized by a surface refractive index; and
a transition region diffused into the porous scaffold, the transition region characterized by a refractive index gradient that transitions between the surface refractive index and a scaffold refractive index that characterizes an internal volume of the porous scaffold.

19.-60. (canceled)

61. A method including:
determining to optically write a voxel at a selected point within a write field at a selected effective power;
using the selected point and the selected effective power performing a lookup in an adjusted power data structure;
obtaining, in response to the lookup and from the adjusted power data structure, an adjusted power at which to set a writing illumination source to illuminate the selected point at the selected effective power; and
optically writing the voxel at the selected point with the writing illumination source set at the adjusted power.

62. The method of claim 61, where optically writing the voxel includes optically writing the voxel in a porous scaffold positioned at least in part within the write field.

63. The method of claim 61, where the adjusted power data structure includes a power adjustment entry for each of a set of points within the write field.

64. The method of claim 63, where the adjusted power data structure includes multiple power adjustment entries for each of the set of points within the write field, the multiple entries defining a power-level dependent adjustment scheme.

65. The method of claim 61, where the write field includes points accessible via motion of a first actuator.

66. The method of claim 65, where:
points accessible only through motion of actuators other than the first actuator are outside the write field; and
the write field includes a one-dimensional write field.

67. The method of claim 65, where the write field includes points accessible via motion of a second actuator.

68. The method of claim 67, where:
points accessible only through motion of actuators other than the first actuator and second actuator are outside the write field; and
the write field includes a two-dimensional write field.

69. The method of claim 65, where the first actuator includes a piezoelectric actuator, a translation stage, a spot-focus-moving actuator, and/or a scaffold-moving actuator.

70. The method of claim 61, where the adjusted power data structure is populated using data generated by writing voxels at each point in the write field at a first test power.

71. The method of claim 61, where the adjusted power data structure is populated using data collected from an image, where the image includes a fluorescence intensity image, a brightfield image, a darkfield image, and/or a confocal image.

72.-151. (canceled)
